(19) United States
(12) Patent Application Publication
(10) Pub. No.: US 2014/0104657 A1
(43) Pub. Date: Apr. 17, 2014

(54) IMAGE FORMATION DEVICE

(71) Applicant: Kazushi Yamaneki, Osaka-shi (JP)

(72) Inventor: Kazushi Yamaneki, Osaka-shi (JP)

(73) Assignee: SHARP KABUSHIKI KAISHA, Osaka-shi, Osaka (JP)

(21) Appl. No.: 14/123,348

(22) PCT Filed: Jan. 23, 2012
(86) PCT No.: PCT/JP2012/051311

§ 371 Date: Dec. 2, 2013

(30) Foreign Application Priority Data
Jun. 21, 2011 (JP) 2011-137322
Jun. 22, 2011 (JP) 2011-138027
Aug. 3, 2011 (JP) 2011-169896

(51) Int. Cl. G06K 15/02

(52) U.S. Cl. CPC G06K 15/02
USPC 358/3.01; 358/1.9

(57) ABSTRACT

To effectively assist a user so that the result of aggregate printing matches the intention of the user. A storage portion (16) stores information regarding the attributes of each page. A display (12) displays a preview screen in which icons corresponding to each page included in the manuscript are arranged in page number sequence. An instruction reception portion (17b) receives, from the user, a modification instruction for instructing that the sequence in which the pages are arranged be modified according to a modification to the sequence in which the icons are arranged, the modification being performed by the user in the preview screen. When the modification instruction is received, a modification aggregation determination portion (17d) determines, on the basis of the information regarding the attributes, whether the modification to the sequence of arrangement will result in pages having different attributes being intermixed with the same aggregate page. If it is determined that pages having different attributes will be intermixed in the same aggregate page, a display controller (17e) controls the display (12) and causes the display (12) to display a warning message.

### TECHNICAL FIELD

The present invention relates to an image formation device which forms an aggregate page in which a plurality of pages included in a manuscript are aggregated into one page.

### BACKGROUND OF THE INVENTION

Conventionally, image formation devices such as an MFP (Multifunction Peripheral) have a color printing function for printing an image in color using each toner of CYMK (cyan, yellow, magenta, black), and a monochrome printing function for printing an image in monochrome using black monochrome toner. Moreover, some image formation devices have a function for aggregating a plurality of pages to one page for printing (N in 1 printing: N is a natural number of 2 and above).

In a case where a color image page and a monochrome image page are intermixed in a plurality of pages to be aggregated, when an image formation device prints aggregate pages by the color printing function, the monochrome image page is also subjected to color printing. In this case, since color printing takes a longer time than monochrome printing, the time required for printing all the aggregate pages becomes long.

As a solution for this problem, Patent Document 1 discloses an image formation device which generates an aggregate page in which color image pages are aggregated and an aggregate page in which monochrome image pages are aggregated to perform color printing for the aggregate page in which the color image pages are aggregated and monochrome printing for the aggregate page in which the monochrome image pages are aggregated.

Moreover, in a case where a color image page and a monochrome image page are intermixed in pages to be aggregated, when color printing is performed even for the monochrome image page, there is also a problem that printing cost becomes high because the cost of color printing is higher than monochrome printing.

As a solution for this problem, Patent Document 2 discloses an image formation device which aggregates image data to a group of image data with the same type (a group of image data composed of one color, a group of image data composed of two colors, or a group of image data composed of three and more colors) by switching sequence or performing color conversion with respect to image data to be aggregated.

In addition, when a color image page and a monochrome image page are intermixed in a plurality of pages to be aggregated, some conventional image formation devices perform color printing for a portion of the color image page and perform printing in black monochrome for a portion of the monochrome image page in an aggregate page.

However, in a case where pictures are included in the portion of the color image page and the portion of the monochrome image page, when printing is performed in black monochrome for the portion of the monochrome image page, the portion of the color image page and the portion of the monochrome image page are not the same in color hue.

As a solution for this problem, Patent Document 3 discloses an image processing device which performs printing using each toner of CMYK for the picture included in the monochrome page in the same manner as the picture of the portion of the color page.

Moreover, some conventional image processing devices perform pre-scan to determine whether or not a color image is included in a manuscript. This image formation device reads all manuscript and stores resulting image data in a memory. The image formation device then reads all image data from the memory to determine whether or not a color image is included in image data to be aggregated.

When a color image is included in the image data to be aggregated, the image formation device reads all image data from the memory, generates aggregate image data in color, and stores the aggregate image data in the memory. When no color image is included in pages to be aggregated, the image formation device reads all image data from the memory, generates aggregate image data in monochrome, and stores the aggregate image data in the memory. Thereafter, the image formation device reads the aggregate image data from the memory to print the aggregate image data.

However, this image formation device needs to store all image data in the memory and therefore needs large memory capacity, and needs to read all image data twice, thus posing a problem of leading to reduction of processing speed.

As a solution for this problem, Patent Document 4 discloses an image formation device which does not read all image data at a time by performing pre-scan but reads image data to be printed sequentially every time aggregate image data is printed.

Moreover, in a case where a color image page and a monochrome image page are intermixed in a plurality of pages to be aggregated, when the image formation device prints an aggregate page, there is a problem that an appearance of a printed image is degraded.

As a solution for this problem, the image formation device of the above-described Patent Document 4 unifies images to color images by applying color processing to the monochrome image page and thereafter performs aggregate printing.

### PRIOR ART DOCUMENT

### Patent Documents

Patent Document 1: Japanese Laid-Open Patent Publication No. 2005-20419
Patent Document 2: Japanese Laid-Open Patent Publication No. 2009-10769
Patent Document 3: Japanese Laid-Open Patent Publication No. 2009-206610
Patent Document 4: Japanese Laid-Open Patent Publication No. 2004-229129

### SUMMARY OF THE INVENTION

### Problem to be Solved by the Invention

However, the conventional technologies of Patent Documents 1 to 4 described above are not for assisting edit working by a user, when the user performs edit such as insertion or deletion of a page included in an aggregate page on a preview screen.

In recent years, though image formation devices capable of performing the above-described edit processing on the preview screen have been developed, there could be also a case where after the user performs the above-described edit on the preview screen, a color image page and a monochrome image page are intermixed in an aggregate page without recognition by the user. When the image formation device is set to perform monochrome printing in such a case, monochrome printing which is not intended by the user is executed wastefully.

In addition, when an image processing device does not permit edit which results in intermixing of a color image page and a monochrome image page in an aggregate page, the user is not able to understand why the above-described edit is not permitted unless the user recognizes the intermixing of the color image page and the monochrome image page in the aggregate page, and the user is not able to perform edit working efficiently.

Given such circumstances, development of devices capable of effectively assisting edit working by a user, when the user performs edit working such as insertion or deletion of a page included in an aggregate page, has been desired.

Moreover, in the conventional technologies of Patent Documents 1 to 4 described above, there is also a problem that the printing result desired by a user is not able to be obtained. Specifically, in the conventional technologies of Patent Documents 1 to 4 described above, since page number sequence or gradation of an image is modified when aggregate printing is performed, it is impossible to realize that color printing is performed for a color image and monochrome printing is performed for a monochrome image without modifying the page number sequence, even if the user desires as such. Thus, development of devices capable of forming an aggregate page in page number sequence and with gradation desired by a user has been also desired.

In view of the above-described actual circumstances, the present invention aims to provide an image formation device capable of effectively assisting a user so that the result of aggregate printing matches the intention of the user.

### Means for Solving the Problem

To solve the above problems, a first technical means of the present invention is an image formation device forming an aggregate page in which a plurality of pages included in a manuscript are aggregated into one page, comprising: a storage portion for storing information of an attribute of each page; a display for displaying a preview screen in which icons corresponding to each page included in the manuscript are arranged in page number sequence; an instruction reception portion for receiving, from a user, a modification instruction for instructing to modify arrangement sequence of each page according to modification to arrangement sequence of the icons performed by the user in the preview screen displayed on the display; a modification aggregation determination portion for determining whether or not the modification to the arrangement sequence results in intermixing of pages the attributes of which are different in a same aggregate page on the basis of the information of the attribute when the instruction reception portion receives the modification instruction; and a display controller for, when the modification aggregation determination portion determines that pages the attributes of which are different are to be intermixed in the same aggregate page, controlling the display to cause the display to display a warning message.

A second technical means is the image formation device of the first technical means, wherein the information of the attribute is information of whether an image of each page is a color image or a monochrome image, a page formation portion for aggregating the plurality of pages in which a color image page and a monochrome image page are intermixed to one page to form a color or monochrome aggregate page is further included, and when it is determined by the modification aggregation determination portion that a color image page and a monochrome image page are to be intermixed in the same aggregate page, the display controller causes the display to display a message for giving notice that a color aggregate page is formed or a monochrome aggregate page is formed by the page formation portion as the warning message.

A third technical means is the image formation device of the first technical means, wherein the information of the attribute is information of whether an image of each page is a color image or a monochrome image, a modification prohibition processor for prohibiting the modification to the arrangement sequence when it is determined by the modification aggregation determination portion that a color image page and a monochrome image page are to be intermixed in the same aggregate page is further included, and when it is determined by the modification aggregation determination portion that a color image page and a monochrome image page are to be intermixed in the same aggregate page, the display controller causes the display to display a message for giving notice that the modification to the arrangement sequence is prohibited as the warning message.

A fourth technical means is an image formation device forming an aggregate page in which a plurality of pages included in a manuscript are aggregated into one page, comprising: a storage portion for storing information of an attribute of each page; a display for displaying a preview screen in which icons corresponding to each page included in the manuscript are arranged in page number sequence; an aggregation determination portion for determining, on the basis of the information of the attribute, whether or not pages the attributes of which are different are to be intermixed in a same aggregate page in a state where each page is arranged in the page number sequence; an instruction reception portion for receiving, from a user, a modification instruction for instructing to modify arrangement sequence of each page according to modification to arrangement sequence of the icons performed by the user in the preview screen displayed on the display; a modification aggregation determination portion for determining whether or not the modification to the arrangement sequence results in intermixing of pages the attributes of which are different in a same aggregate page on the basis of the information of the attribute when the instruction reception portion receives the modification instruction; and a display controller for, when it is determined by the aggregation determination portion and/or the modification aggregation determination portion that pages the attributes of which are different are to be intermixed in the same aggregate page, controlling the display to cause the display to display a warning message.

A fifth technical means is the image formation device of the fourth technical means, wherein the information of the attribute is information of whether an image of each page is a color image or a monochrome image, and when it is determined by the aggregation determination portion and/or the modification aggregation determination portion that a color image page and a monochrome image page are to be intermixed in the same aggregate page, the display controller causes the display to display a message for giving notice that a color aggregate page is formed or a monochrome aggregate page is formed as the warning message.

A sixth technical means is the image formation device of the fourth or the fifth technical means, wherein when the aggregation determination portion and/or the modification aggregation determination portion determines that pages the attributes of which are different are to be intermixed in the same aggregate page, the display displays a preview screen in which the icons are arranged in arrangement sequence before the modification and arrangement sequence after the modification.

A seventh technical means is the image formation device of the sixth technical means, wherein a page formation portion for forming the aggregate page is further included, the instruction reception portion receives any one of selections of the arrangement sequence before the modification and the arrangement sequence after the modification, and the page formation portion forms the aggregate page in the selected arrangement sequence.

An eighth technical means is the image formation device of any one of the first to the seventh technical means, wherein the instruction reception portion receives, from the user, a modification instruction for instructing to insert an icon corresponding to a page included in a manuscript targeted for formation of the aggregate page ahead of an icon corresponding to a different page of the manuscript to modify the arrangement sequence of each page.

A ninth technical means is the image formation device of any one of the first to the eighth technical means, wherein the instruction reception portion receives, from the user, a modification instruction for instructing to insert an icon corresponding to a page included in a manuscript different from the manuscript ahead of a page included in the manuscript to modify the arrangement sequence of each page, and when the instruction reception portion receives the modification instruction, the modification aggregation determination portion determines whether or not the modification to the arrangement sequence results in intermixing of pages the attributes of which are different in the same aggregate page on the basis of the information of the attribute and information of an attribute of the page included in the different manuscript.

A tenth technical means is the image formation device of the ninth technical means, wherein the display arranges icons corresponding to each page of the manuscript in page number sequence and displays a preview screen in which icons corresponding to each page of the different manuscript are arranged in page number sequence.

An eleventh technical means is the image formation device of any one of the first to the tenth technical means, wherein the instruction reception portion receives from the user a modification instruction for instructing to delete a page included in the manuscript to modify the arrangement sequence of each page.

A twelfth technical means is the image formation device of any one of the first to the eleventh technical means, wherein the modification aggregation determination portion determines, as to an aggregate page including a first page among the pages whose arrangement sequence is modified, whether or not pages the attributes of which are different are to be intermixed in the aggregate page as well as determines, as to a different aggregate page including a second page which follows the first page, whether or not pages the attributes are which is different are to be intermixed in the different aggregate page.

A thirteenth technical means is an image formation device forming an aggregate page in which a plurality of pages included in a manuscript are aggregated into one page, comprising: a storage portion for storing information of an attribute of each page; an aggregation determination portion for determining whether or not an attribute of a page changes between previous and following pages on the basis of the information of the attribute stored in the storage portion when each page is aggregated in page number sequence to form the aggregate page, and a page formation portion for performing page break in the aggregate page to form an aggregate page including the following page separately from an aggregate page including the previous page when it is determined by the aggregation determination portion that the attribute of the page changes between the previous and following pages.

A fourteenth technical means is the image formation device of the thirteenth technical means, wherein the attribute is gradation of image data of a page.

A fifteenth technical means is the image formation device of the thirteenth or the fourteenth technical means, wherein an instruction reception portion for receiving an edit instruction of arrangement sequence of pages from a user is further included, and when the arrangement sequence of pages is modified, the aggregation determination portion performs the determination.

### Effect of the Invention

According to the present invention, it is possible to effectively assist a user so that the result of aggregate printing matches the intention of the user. For example, a preview screen in which icons corresponding to each page included in a manuscript are arranged in page number sequence is displayed, a modification instruction for instructing to modify arrangement sequence of each page according to modification to arrangement sequence of the icons performed by the user on the displayed preview screen is received from the user, and when the modification instruction is received, whether or not performing the modification to the arrangement sequence results in intermixing of pages having a different attribute in a same aggregate page is determined on the basis of information of an attribute of image data of each page stored in a storage portion, and when it is determined that pages having a different attribute are to be intermixed in the same aggregate page, a warning message is displayed, so that it is possible to effectively assist page edit working by the user, when the user performs edit working such as insertion or deletion of a page included in an aggregate page.

Moreover, a preview screen in which icons corresponding to each page included in a manuscript are arranged in page number sequence is displayed, whether or not pages having a different attribute are to be intermixed in a same aggregate page in a state where each page is arranged in page number sequence is determined on the basis of information of an attribute of each page stored in the storage portion, and when a modification instruction for instructing to modify arrangement sequence of each page according to modification to arrangement sequence of the icons performed by the user in the displayed preview screen is received from the user, whether or not performing the modification to the arrangement sequence results in intermixing of pages having a different attribute in a same aggregate page is determined on the basis of the above-described information of the attribute, and when it is determined that pages having a different attribute are to be intermixed in the same aggregate page, a warning message is displayed, so that it is possible to effectively assist page edit working by the user, when the user performs edit working such as insertion or deletion of a page included in an aggregate page.

Further, when an aggregate page is formed by aggregating each page in page number sequence, whether or not a page attribute changes between previous and following pages is determined on the basis of information of an attribute of each page stored in the storage portion, and when it is determined that the page attribute changes between previous and following pages, page break is performed in aggregate pages to form an aggregate page including the following page separately from an aggregate page including the previous page, so that it is possible to form aggregate pages in page number sequence and with gradation desired by the user.

### BRIEF DESCRIPTION OF DRAWINGS

FIG. 1 is a view explaining an example of page aggregate processing according to an embodiment 1 of the present invention.

FIG. 2 is a view explaining an example of page aggregate processing when page insertion is performed.

FIG. 3 is a view explaining another example of page aggregate processing when page insertion is performed.

FIG. 4 is a block diagram showing an example of a functional structure of an image formation device according to the embodiment 1 of the present invention.

FIG. 5 is a view showing an example of a preview screen for receiving a page edit instruction from a user.

FIG. 6 is a view showing an example of a preview screen for receiving a page edit instruction for inserting a page included in a different manuscript from a user.

FIG. 7 is a view showing an example of a preview screen in which a warning message is displayed.

FIG. 8 is a flowchart showing an example of processing procedure of image formation processing according to the embodiment 1 of the present invention.

FIG. 9 is a flowchart explaining an example of processing procedure of normal print processing.

FIG. 10 is a flowchart explaining an example of processing procedure of aggregate print processing.

FIG. 11 is a view explaining an example of prohibition processing of page edit processing.

FIG. 12 is a view explaining an example of page aggregate processing according to an embodiment 2 of the present invention.

FIG. 13 is a view showing an example of a preview screen in which a warning message is displayed.

FIG. 14 is a view explaining an example of page aggregate processing when page insertion is performed.

FIG. 15 is a view showing another example of a preview screen in which a warning message is displayed.

FIG. 16 is a view showing an example of a preview screen in which icons of aggregate pages before and after page insertion are displayed.

FIG. 17 is a block diagram showing an example of a functional structure of an image formation device according to the embodiment 2 of the present invention.

FIG. 18 is a flowchart showing an example of processing procedure of image formation processing according to the embodiment 2 of the present invention.

FIG. 19 is a flowchart explaining an example of processing procedure of normal print processing.

FIG. 20 is a flowchart explaining an example of processing procedure of aggregate print processing.

FIG. 21 is a flowchart explaining an example of processing procedure of aggregate print processing.

FIG. 22 is a flowchart explaining an example of processing procedure of aggregate print processing.

FIG. 23 is a view explaining an example of page aggregate processing when a page included in different manuscript is inserted.

FIG. 24 is a view explaining an example of page aggregate processing when a page is deleted.

FIG. 25 is a view explaining an example of page aggregate processing according to an embodiment 3 of the present invention.

FIG. 26 is a block diagram showing an example of a functional structure of an image formation device according to the embodiment 3 of the present invention.

FIG. 27 is a view showing an example of printing page information.

FIG. 28 is a flowchart showing an example of processing procedure of image formation processing according to the embodiment 3 of the present invention.

FIG. 29 is a flowchart showing an example of processing procedure of scheduling processing for aggregate printing.

FIG. 30 is a flowchart showing an example of processing procedure of scheduling processing for non-aggregate printing.

FIG. 31 is a view showing an example of printing page information when aggregate printing is not performed.

FIG. 32 is a flowchart showing an example of processing procedure of print processing.

### PREFERRED EMBODIMENT OF THE INVENTION

### Embodiment 1

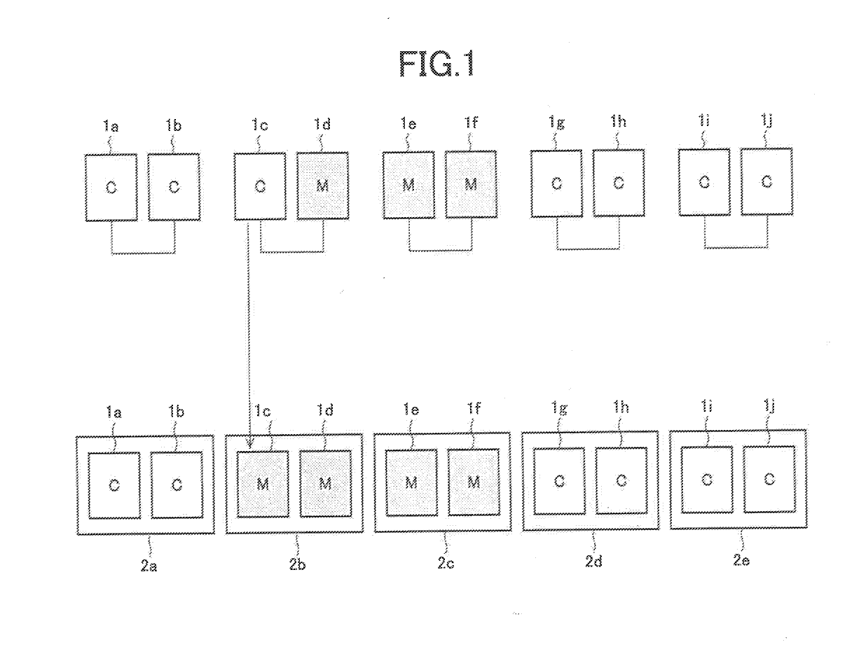

Description will hereinafter be given specifically for an embodiment 1 of the present invention with reference to drawings. First, description will be given for image formation processing according to the embodiment 1 of the present invention. FIG. 1 is a view explaining an example of page aggregate processing according to the embodiment 1 of the present invention.

In FIG. 1, respective pages 1a to 1j of manuscript images read by an image formation device in sequence are shown. A mark of “C” assigned to a page shows that the page is a color image, and a mark of “M” shows that the page is a monochrome image. In addition, in a touch panel of the image formation device, icons corresponding to each of the pages 1a to 1j shown in FIG. 1 are displayed in page number sequence as a preview screen. Here, the icon is such that an image of each of the pages 1a to 1j of the manuscript image is reduced to display each image so as to be visible.

Moreover, the image formation device is a device which forms an image, such as an MFP (Multifunction Peripheral), a printer, a copier or a facsimile. Description will be given below for a case where the image formation device is an MFP.

This image formation device is provided with an aggregate copy function for aggregating a plurality of pages included in a manuscript read by scanning to one page for printing (N in 1 copy: N is a natural number of 2 and above). In this aggregate copy, an aggregate page in which the plurality of pages which are read are aggregated into one page is generated and the generated aggregate page is printed.

In FIG. 1, respective aggregate pages 2a to 2e that two pages are aggregated into one page are shown. Note that, description will be given below for a case where 2 in 1 copy is performed, but without limitation thereto, the present invention is also applicable to other aggregate copy such as 4 in 1 copy.

When scanning manuscript, this image formation device determines whether each page included in the manuscript is a color image page or a monochrome image page to perform color printing for the color manuscript page and monochrome printing for the monochrome image page.

However, in a case where aggregate copy is performed when a color image page and a monochrome image page are intermixed in an aggregate page, the image formation device converts the color image page into a monochrome image page and generates an aggregate page which includes only monochrome image pages to perform monochrome printing for the generated aggregate page.

For example, in FIG. 1, when pages to be aggregated are all color image pages (page 1a and page 1b, page 1g and page 1h, page 1i and page 1j), the image processing device generates aggregate pages of the color images (aggregate pages 2a, 2d, 2e).

Moreover, when pages to be aggregated are all monochrome image pages (page 1e and page 1f), the image formation device generates an aggregate page of the monochrome image (aggregate page 2c).

Further, when pages to be aggregated include the color image page (page 1c) and the monochrome image page (page 1d), the image formation device converts the color image page (page 1c) into a monochrome image page and generates the aggregate page (aggregate page 2b) which includes only monochrome image pages.

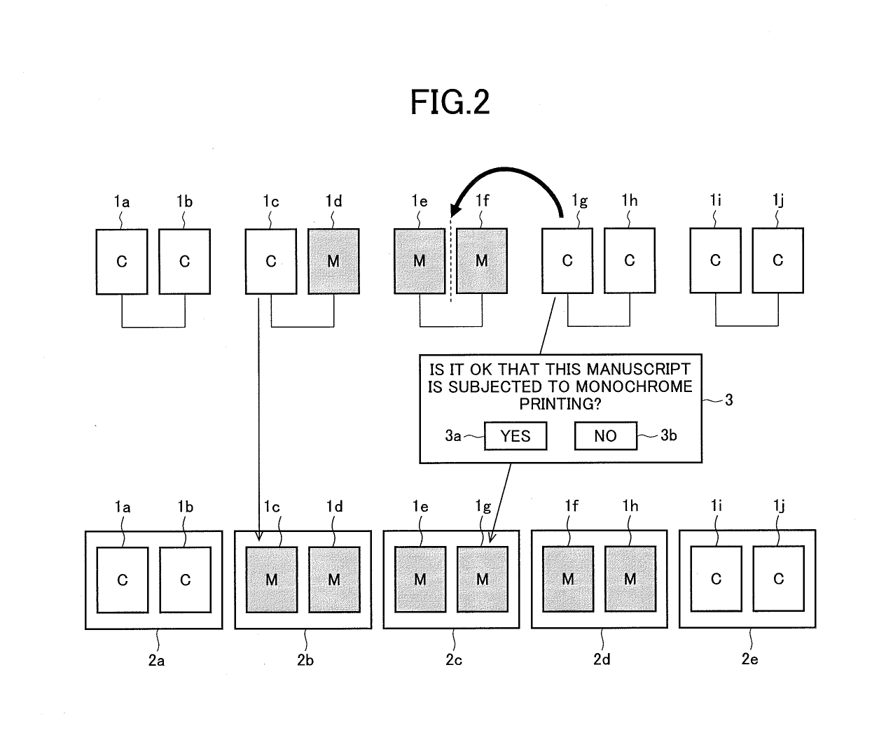

FIG. 2 is a view explaining an example of page aggregate processing when page insertion is performed. In FIG. 2, shown is a case where the page 1g is inserted ahead of the page 1f. In the touch panel of the image formation device, icons corresponding to each of the pages 1a to 1j shown in FIG. 2 are shown in page number sequence as a preview screen, and a user instructs the image formation device to execute insertion processing of the page 1g by dragging the page 1g in the touch panel to insert the page 1g ahead of the page 1f.

Similarly to the case of FIG. 1, when pages to be aggregated are all color image pages (page 1a and page 1b, page 1i and page 1j), the image formation device generates aggregate pages of the color images (aggregate pages 2a, 2e) to perform color printing of the aggregate pages.

Moreover, when pages to be aggregated are color image pages and monochrome image pages (page 1c and page 1d, page 1e and page 1g, page 1f and page 1h), the image formation device converts the color image pages into monochrome image pages and generates aggregate pages which include only monochrome image pages (aggregate pages 2b, 2c, 2d) to perform monochrome printing of the aggregate pages.

Here, when the page 1g is inserted between the page 1e and the page 1f to modify arrangement sequence of the pages 1f to 1j, the image processing device determines whether or not the modification to the arrangement sequence results in intermixing of a color image page and a monochrome image page in the same aggregate page.

In the example of FIG. 2, as a result of insertion of the page 1g, since the color image page and the monochrome image pages are intermixed in the aggregate page 2c and the page 1g is subjected to monochrome printing, the image processing device displays a warning message 3 to the effect that the page 1g is subjected to monochrome printing. In addition, since the page 1h is also subjected to monochrome printing, the image processing device displays the warning message 3 to the effect that the page 1h is subjected to monochrome printing also for the page 1h (not shown).

Thereby, when the user performs edit of a page included in an aggregate page, it is possible to notify the user that print processing of the page becomes monochrome printing and to effectively assist page edit working by the user.

Moreover, the image formation device displays a permission instruction reception area 3a for receiving, from the user, an instruction to permit that the pages 1g and 1h are subjected to monochrome printing, and a prohibition instruction reception area 3b for receiving, from the user, an instruction not to permit it, together with the warning message 3 in the touch panel.

When the user touches the permission instruction reception area 3a in the warning message 3 displayed for each of the pages 1g and 1h, the image processing device then executes insertion processing of the page 1g. Thereafter, when receiving a printing instruction of the aggregate pages 2a to 2e from the user, the image processing device performs printing of the aggregate pages 2a to 2e. In this case, the image processing device performs color printing for the aggregate pages 2a and 2e and performs monochrome printing for the aggregate pages 2b to 2d.

When the user touches the prohibition instruction reception area 3b, the image processing device cancels execution of the insertion processing of the page 1g. When a printing instruction is received from the user, the image processing device then executes printing of the aggregate pages in which pages are aggregated in the original arrangement sequence. Note that, insertion processing of the page 1g may be executed without cancelling execution of the insertion processing so as to perform color printing for the aggregate pages 2c and 2d including the pages 1g and 1h for which the prohibition instruction reception area 3b is touched.

In this manner, since whether or not a color image page and a monochrome image page are to be intermixed in the aggregate page 2c is determined with respect to the aggregate page 2c including the page 1g among the pages 1f to 1j whose arrangement sequence is modified as well as whether or not a color image page and a monochrome image page are to be intermixed in the aggregate page 2c is determined with respect to the aggregate page 2d including the pages 1f and 1h which follow the page 1g, it is possible to notify the user that monochrome printing is performed not only for the aggregate page 2c in which the page 1g is inserted but also for other page 1h which is affected by the insertion of the page 1g and to effectively assist page edit working by the user.

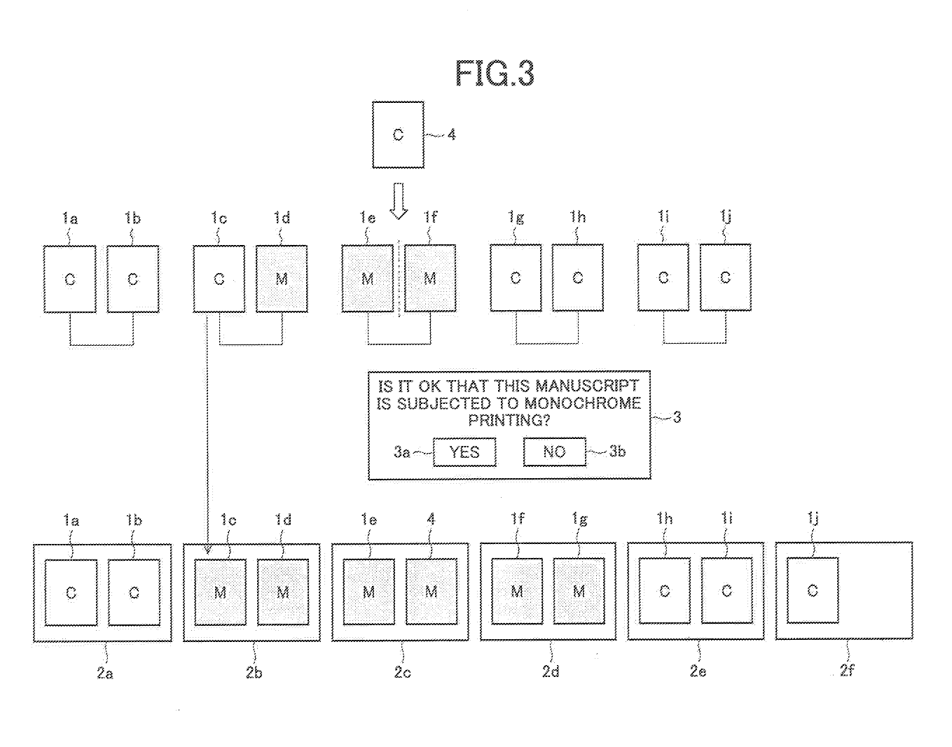

FIG. 3 is a view explaining another example of page aggregate processing when page insertion is performed. In FIG. 3, shown is a case where a page 4 which is read from different manuscript from the manuscript including the pages 1a to 1j is inserted ahead of the page 1f.

Here, in the touch panel of the image formation device, icons corresponding to each page of the different manuscript including the page 4 are displayed with the icons corresponding to the pages 1a to 1j as a preview screen, and the user instructs the image formation device to execute insertion processing of the page 4 by dragging the page 4 displayed in the touch panel to insert the page 4 ahead of the page 1f.

Similarly to the case of FIG. 1, when pages to be aggregated after the page 4 is inserted are all color image pages (page 1a and page 1b, page 1h and page 1i), the image formation device generates aggregate pages of the color images (aggregate pages 2a, 2e) and performs color printing of the aggregate pages. Note that, the aggregate page 2f is to include only the page 1j, and the page 1j is the color image, and the image formation device therefore generates an aggregate page of the color image and performs color printing of the aggregate page.

Moreover, when pages to be aggregated are color image pages and monochrome image pages (page 1c and page 1d, page 1e and page 4, page 1f and page 1g), the image formation device converts the color image pages into monochrome image pages and generates aggregate pages (aggregate pages 2b, 2c, 2d) which include only the monochrome image pages to perform monochrome printing of the aggregate pages.

Here, when the page 4 is inserted ahead of the page 1f to modify arrangement sequence of the pages 1f to 1j, the image processing device determines whether or not the modification to the arrangement sequence results in intermixing of a color image page and a monochrome image page in the same aggregate page.

In the example of FIG. 3, as a result of insertion of the page 4, since the color image page and the monochrome image page are intermixed in the aggregate page 2c and the page 4 is subjected to monochrome printing, the image processing device displays the warning message 3 to the effect that the page 4 is subjected to monochrome printing. In addition, since the page 1g is also subjected to monochrome printing, the image processing device displays the warning message 3 to the effect that the page 1g is subjected to monochrome printing also for the page 1g (not shown).

Further, the image formation device displays a permission instruction reception area 3a for receiving, from the user, an instruction to permit that the pages 4 and 1g are subjected to monochrome printing, and a prohibition instruction reception area 3b for receiving, from the user, an instruction not to permit it, together with the warning message 3 in the touch panel.

When the user touches the permission instruction reception area 3a in the warning message 3 displayed for each of the pages 4 and 1g, the image processing device then executes insertion processing of the page 4. Thereafter, when receiving a printing instruction of the aggregate pages 2a to 2f from the user, the image processing device performs printing of the aggregate pages 2a to 2f. In this case, the image processing device performs color printing for the aggregate pages 2a, 2e and 2f and performs monochrome printing for the aggregate pages 2b to 2d.

When the user touches the prohibition instruction reception area 3b, the image processing device cancels execution of the insertion processing of the page 4. When a printing instruction is received from the user, the image processing device then executes printing of the aggregate pages in which pages are aggregated in the original arrangement sequence. Note that, insertion processing of the page 4 may be executed without cancelling execution of the insertion processing so as to perform color printing for the aggregate pages 2c and 2d including the pages 4 and 1g for which the prohibition instruction reception area 3b is touched.

In this manner, when it is determined that a color image page and a monochrome image page are to be intermixed in the same aggregate page as a result of the modification to the arrangement sequence of pages in the preview screen by the user, the warning message 3 showing that the monochrome aggregate page is printed is displayed, so that it is possible to notify the user that the monochrome aggregate page is printed and to effectively assist page edit working by the user.

In addition, since an instruction to modify arrangement sequence of pages performed by inserting an icon ahead of another icon in the same manuscript or inserting an icon of different manuscript ahead of an icon of a page of manuscript to be printed by the user in the preview screen is received, it is possible to simplify page edit working by the user.

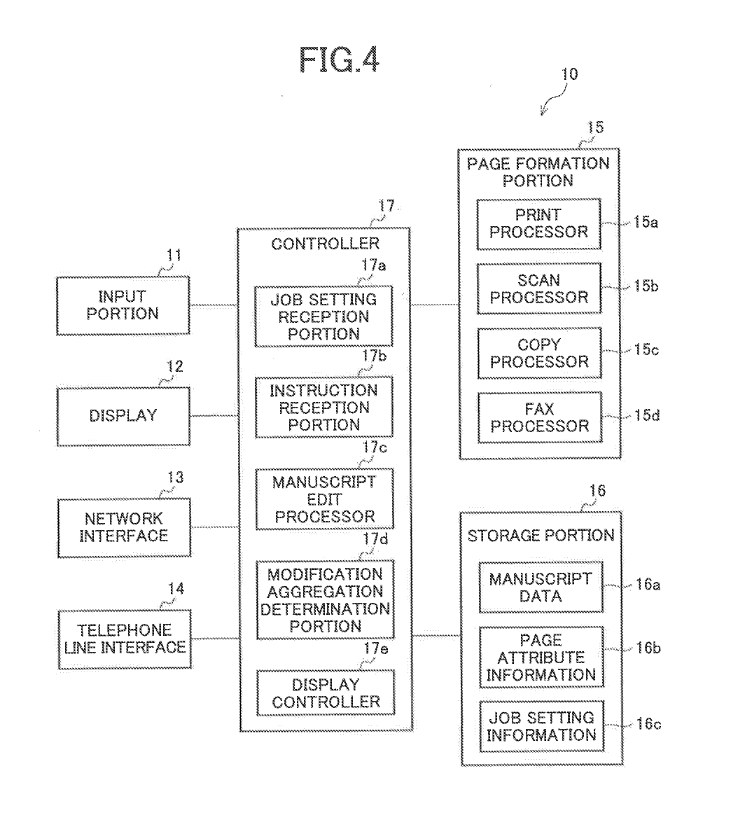

Next, description will be given for a functional structure of an image formation device 10 according to the embodiment 1 of the present invention. FIG. 4 is a block diagram showing an example of a functional structure of the image formation device 10 according to the embodiment 1 of the present invention. As shown in FIG. 4, this image formation device 10 is provided with an input portion 11, a display 12, a network interface 13, a telephone line interface 14, a page formation portion 15, a storage portion 16 and a controller 17.

The input portion 11 is an input device consisting of a touch pad and the like. The display 12 is a display device consisting of a liquid crystal panel and the like. The input portion 11 and the display 12 constitute the touch panel in combination.

The network interface 13 is a processor which performs communication with other communication device through a network such as a LAN (Local Area Network). The telephone line interface 14 is a processor which performs communication with other device such as a Fax device through a telephone line.

The page formation portion 15 is a processor which executes various image formation processing. This page formation portion 15 is provided with a print processor 15a, a scan processor 15b, a copy processor 15c, and a Fax processor 15d.

The print processor 15a is a processor which performs print processing of manuscript data. For example, at the time of aggregate copy, when pages aggregated into one page are all color images, the print processor 15a generates image data of an aggregate page of the color image and performs color printing of the generated image data. In addition, when pages aggregated into one page are all monochrome images, the print processor 15a generates image data of an aggregate page of the monochrome image and performs monochrome printing of the generated image data.

Further, when pages aggregated into one page include both color image page and monochrome image page, the print processor 15a converts the color image page into a monochrome image page and generates image data of an aggregate page which includes only monochrome image pages to perform monochrome printing of the generated image page.

The scan processor 15b is a processor which performs scan processing of manuscript. After executing scan processing of manuscript, this scan processor 15b also performs processing for determining whether image data obtained by the scan processing is a color image or a monochrome image and processing for allocating a page number to the image data together.

The copy processor 15c is a processor which performs copy processing of manuscript data. When performing copy processing, the copy processor 15c requests the scan processor 15b to scan manuscript, and requests the print processor 15a to print the resulting image data. The Fax processor 15d is a processor which performs Fax transmission/reception processing.

The storage portion 16 is a storage device such as a memory or a hard disc device. This storage portion 16 stores data such as manuscript data 16a, page attribute information 16b and job setting information 16c.

The manuscript data 16a is image data of manuscript read by the scan processor 15b and image data of Fax received by the Fax processor 15d.

The page attribute information 16b is attribute information of each page in which image data is stored as the manuscript data 16a. Specifically, the page attribute information 16b includes information of whether image data of each page stored as the manuscript data 16a is a color image or a monochrome image, information of a page number of each page, and the like.

The job setting information 16c is setting information of a job inputted by operating the input portion 11 by the user. For example, the job setting information 16c includes information of whether or not to perform page aggregation, information of the number of pages to be included in one page when page aggregation is performed, information for, when a page of manuscript different from manuscript to be copied is inserted to perform page edit, specifying the different manuscript to be displayed in the preview screen, and the like.

The controller 17 is a controlling device such as a CPU (Central Processing Unit) that controls the image formation device 10 totally. This controller 17 is provided with a job setting reception portion 17a, an instruction reception portion 17b, a manuscript edit processor 17c, a modification aggregation determination portion 17d, and a display controller 17e.

The job setting reception portion 17a is a processor which receives setting information of a job from the user through the input portion 11. The job setting reception portion 17a stores the received setting information in the storage portion 16 as the job setting information 16c.

The instruction reception portion 17b is a processor which receives an instruction to edit manuscript to be printed from the user through the input portion 11. For example, the instruction reception portion 17b receives an instruction to modify arrangement sequence of pages by page insertion or the like from the user. The manuscript edit processor 17c is a processor which performs processing for editing manuscript to be printed in accordance with the edit instruction received by the instruction reception portion 17b.

The modification aggregation determination portion 17d is a processor which, when the instruction reception portion 17b receives an instruction to modify arrangement sequence of pages, determines whether or not the modification to the arrangement sequence results in intermixing of a color image page and a monochrome image page in the same aggregate page.

The display controller 17e is a processor which controls display of information for the display 12. For example, when it is determined by the modification aggregation determination portion 17d that a color image page and a monochrome image page are to be intermixed in the same aggregate page, the display controller 17e controls the display 12 and causes the display 12 to display the warning message 3.

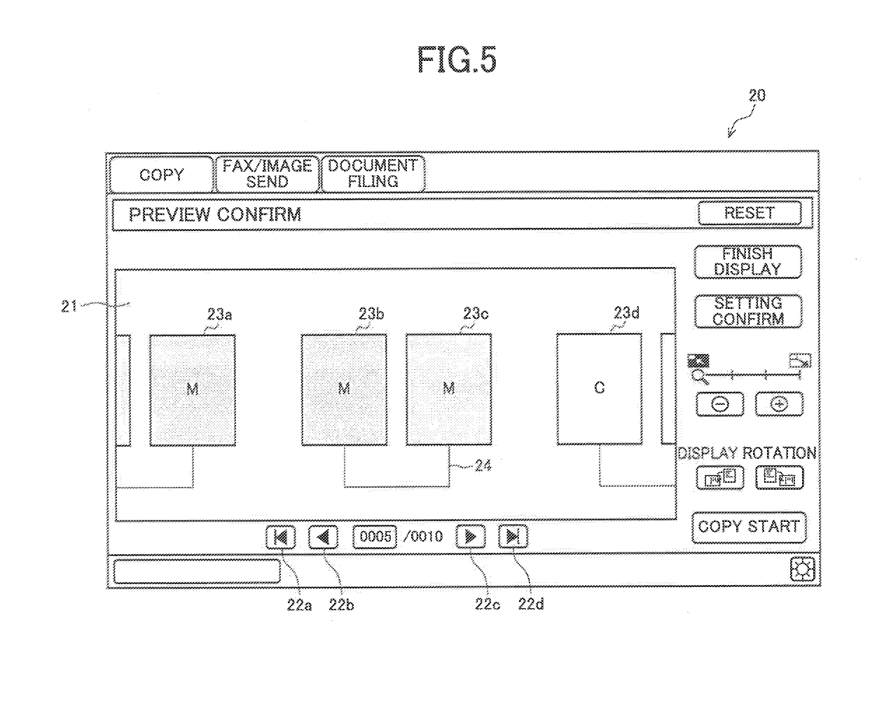

FIG. 5 is a view showing an example of a preview screen 20 for receiving a page edit instruction from the user. This preview screen 20 is displayed by the display 12 under the control by the display controller 17e.

As shown in FIG. 5, in this preview screen 20, a page display area 21 and go buttons 22a to 22d are displayed. In addition, in the page display area 21, icons 23d to 23g corresponding to each page explained in FIGS. 1 to 3 are displayed.

Here, a mark of “C” assigned to the icon 23d shows that a page corresponding to the icon 23d is a color image, and a mark of “M” assigned to the icons 23a to 23c shows that pages corresponding to these icons 23a to 23c are monochrome images. Moreover, icons of each page aggregated into one page (for example, icon 23b and icon 23c) are connected by a connection line 24 so that the user is able to confirm each page aggregated into one page easily.

In addition, when the user touches the go buttons 22a to 22d, display of the icons 23a to 23d is scrolled in the direction corresponding to the go buttons 22a to 22d, so that an icon which is not displayed in the page display area 21 becomes displayed. Further, when the user drags the icons 23a to 23d to move the icons 23a to 23d outside the page display area 21, the page display area 21 is scrolled according to the movement, so that an icon which is not displayed in the page display area 21 becomes displayed.

By dragging any of the icons to insert the icon ahead of a different icon in this page display area 21, the user is able to instruct the image formation device to insert a page corresponding to the dragged icon ahead of a page corresponding to the different icon.

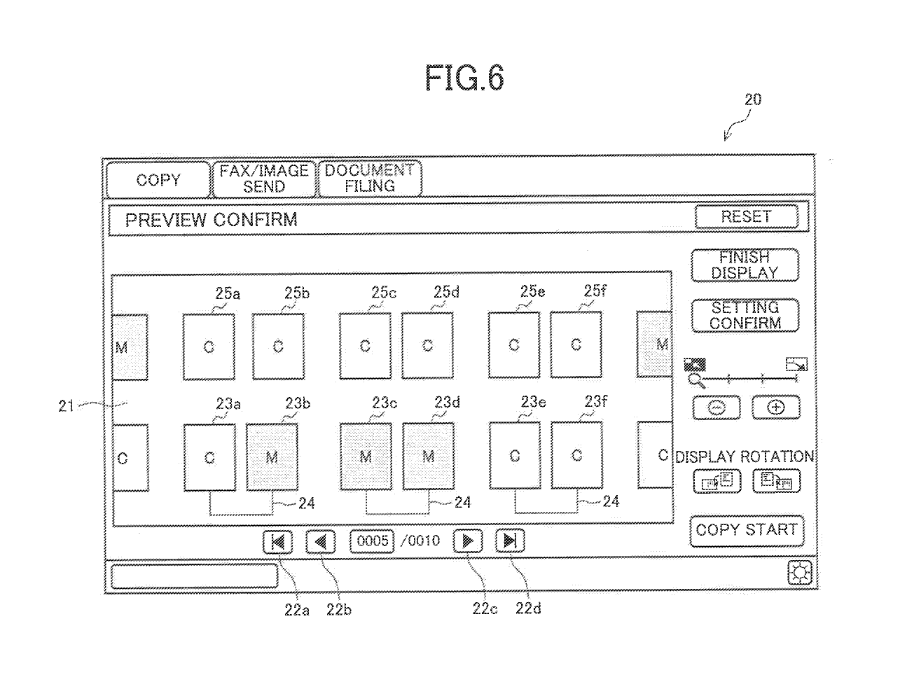

FIG. 6 is a view showing an example of the preview screen 20 for receiving a page edit instruction for inserting a page included in different manuscript from the user. This preview screen 20 is also displayed by the display 12 under the control by the display controller 17e. Here, icons of each page aggregated into one page (icon 23a and icon 23b, icon 23c and icon 23d, icon 23e and icon 23f) are connected by the connection line 24 so that the user is able to easily check each page that is aggregated into one page.

In this preview screen 20, the page display area 21 and the go buttons 22a to 22d are displayed. In addition, in the page display area 21, icons 23a to 23f showing each page of first manuscript targeted for aggregation and icons 25a to 25f showing each page of second manuscript are displayed.

The go buttons 22a to 22d are the same as the go buttons 22a to 22d explained in FIG. 5. In addition, when the user drags the icons 23a to 23f and 25a to 25f to move the icons 23a to 23f and 25a to 25f outside the page display area 21, the page display area 21 is scrolled according to the movement, so that an icon which is not displayed in the page display area 21 becomes displayed.

By dragging any of the icons of the second manuscript to insert the icon ahead of an icon of the first manuscript in this page display area 21, the user is able to instruct the image formation device to insert a page corresponding to the dragged icon ahead of a page corresponding to the icon.

In this manner, the display 11 displays the preview screen 20 in which icons corresponding to each page of the first manuscript are arranged in page number sequence as well as icons corresponding to each page of the second manuscript are arranged in page number sequence, and the instruction reception portion 17b receives page edit processing in the preview screen 20, so that when inserting a page included in the second manuscript between pages included in the first manuscript, it is possible to simplify edit working by the user.

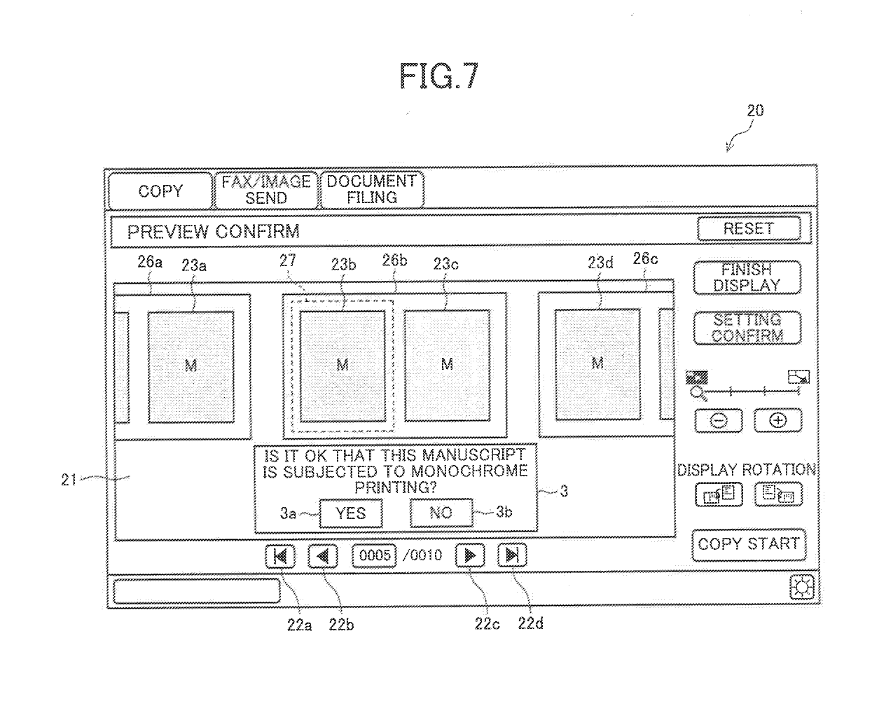

FIG. 7 is a view showing an example of the preview screen 20 in which the warning message 3 is displayed. This preview screen 20 is also displayed by the display 12 under the control by the display controller 17e. This warning message 3 is the same as the warning message 3 explained with the use of FIG. 2.

Here, in the page display area 21, in addition to the warning message 3, icons 23a to 23d of pages aggregated into one page and icons 26a to 26c showing each aggregate page are displayed.

Moreover, the icon 23b of the color image page subjected to monochrome printing because of being aggregated with a monochrome image is displayed in a form different from other icons 23a, 23c and 23d. For example, as shown in FIG. 7, the icon 23b is highlighted by being surrounded with a highlighting frame line 27 or the like. In addition, the highlighting for the icon 23b may be blinking display or display using a color different from a display color of other icons.

In this manner, by displaying the icon 23b of the color image page subjected to monochrome printing because of being aggregated with a monochrome image in a form different from other icons 23a, 23c and 23d, the user is able to easily recognize for which page the warning message 3 is displayed.

Moreover, in the example of FIG. 7, the warning message 3 is displayed in the lower side of the icon 23b, but may be displayed in the upper side, right side or left side of the icon 23b or displayed being overlapped with the icon 23b.

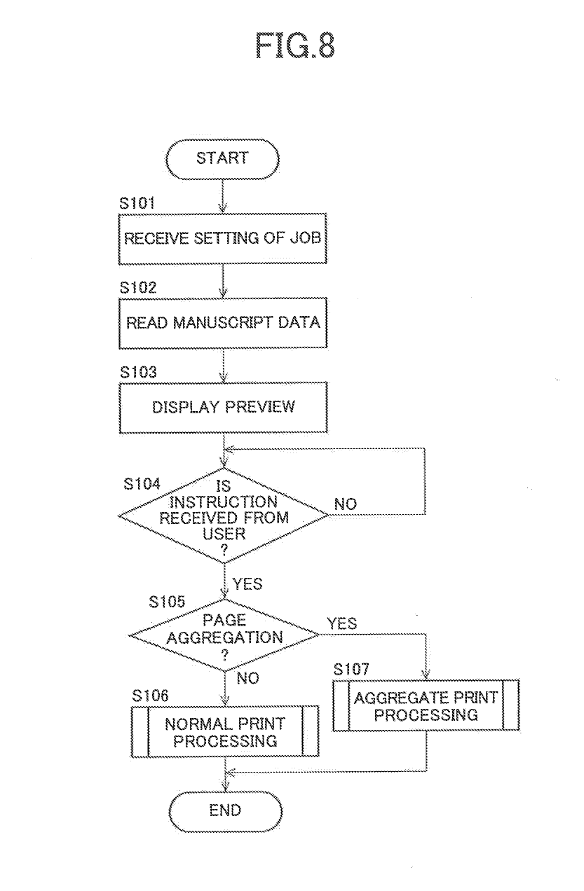

Next, description will be given for processing procedure of image formation processing according to the embodiment 1 of the present invention. FIG. 8 is a flowchart showing an example of processing procedure of image formation processing according to the embodiment 1 of the present invention.

First, the job setting reception portion 17a of the image formation device 10 receives inputting of job setting information from the user through the input portion 11 (step S101). The job setting information is information of whether or not to perform page aggregation, information of the number of pages to be included in one page when page aggregation is performed, information for, when a page of manuscript different from manuscript to be copied is inserted to perform page edit, specifying the different manuscript to be displayed in the preview screen as explained in FIG. 3, and the like.

The display controller 17e then reads the manuscript data 16a from the storage portion 16 (step S102). Thereafter, on the basis of the manuscript data 16a, the display controller 17e generates image data of the preview screen in which each page of manuscript to be printed is displayed, and controls the display 12 to display the generated preview screen (step S103).

Here, the display controller 17e refers to the job setting information inputting of which is received at step S101, and when it is set to perform page aggregation in the setting information, displays the preview screen 20 in which each page to be aggregated into one page is connected by the connection line 24 as shown in FIG. 5.

In addition, the display controller 17e refers to the job setting information inputting of which is received at step S101, and, when information for specifying different manuscript to be displayed in the preview screen is set in the setting information, displays the preview screen 20 including the icons 25a to 25f showing each page of the different manuscript and the icons 23a to 23f showing each page of manuscript to be printed as shown in FIG. 6.

Thereafter, the instruction reception portion 17b determines whether or not an execution instruction of processing performed in the preview screen is received from the user through the input portion 11 (step S104). When the execution instruction of processing is not received from the user (in the case of NO at step S104), the determination processing of step S104 is continued until the execution instruction is received.

When the execution instruction of processing is received from the user (in the case of YES at step S104), the modification aggregation determination portion 17d refers to the job setting information inputting of which is received at step S101 to determine whether or not it is set to perform page aggregation in the setting information (step S105).

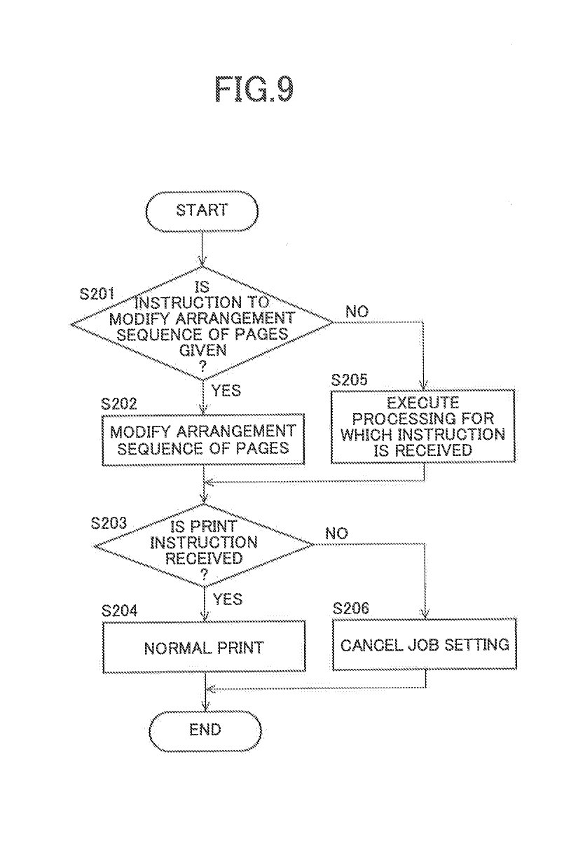

When it is not set to perform page aggregation in the setting information (in the case of NO at step S105), the modification aggregation determination portion 17d, the display controller 17e and the print processor 15a execute normal print processing which does not involve page aggregation (step S106). This normal print processing will be explained specifically below with the use of FIG. 9.

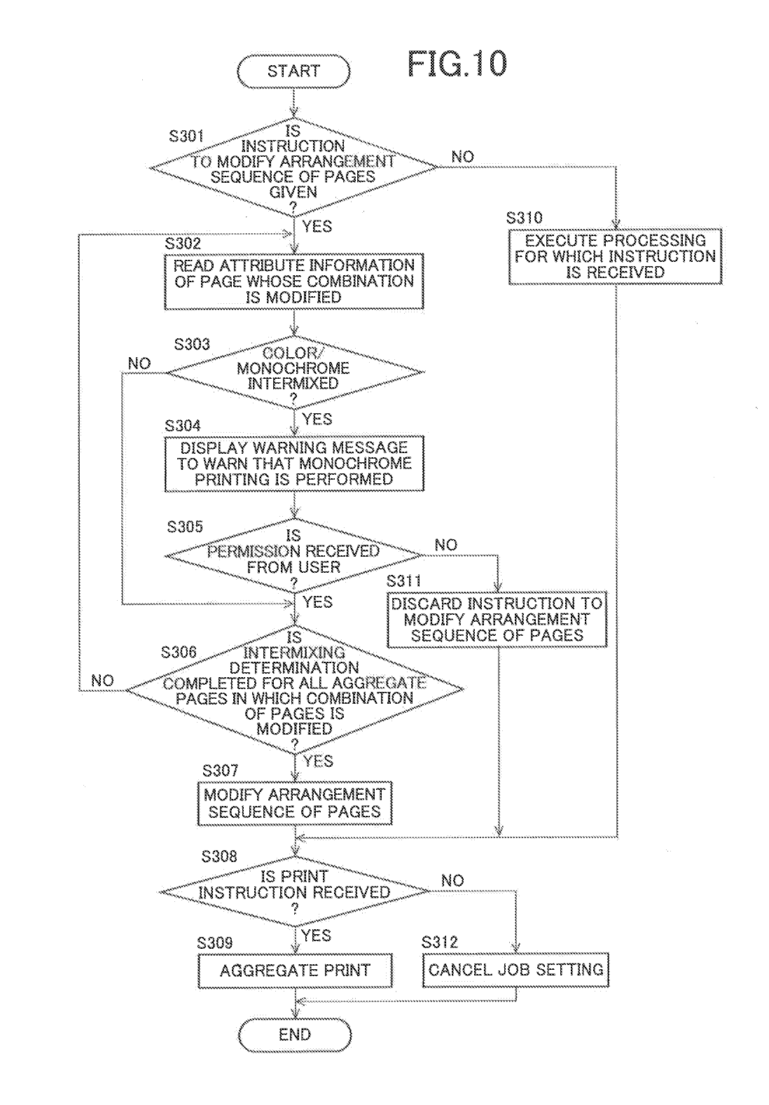

When it is set to perform page aggregation in the setting information (in the case of YES at step S105), the modification aggregation determination portion 17d, the display controller 17e and the print processor 15a execute aggregate print processing which involves page aggregation (step S107). This aggregate print processing will be explained specifically below with the use of FIG. 10.

After the processing of step S106 or the processing of step S107, this image formation processing ends.

Next, description will be given for the normal print processing shown in step S106 of FIG. 8. FIG. 9 is a flowchart explaining an example of processing procedure of the normal print processing.

First, the instruction reception portion 17b of the image formation device 10 determines whether or not the execution instruction of processing received from the user at step S104 of FIG. 8 is an instruction to modify arrangement sequence of pages such as insertion of a page (step S201).

When the execution instruction is the instruction to modify arrangement sequence of pages (in the case of YES at step S201), the manuscript edit processor 17c modifies arrangement sequence of pages in accordance with the instruction to modify arrangement sequence of pages received at step S104 of FIG. 8 (step S202).

When the execution instruction is not the instruction to modify arrangement sequence of pages (in the case of NO at step S201), the manuscript edit processor 17c executes the processing for which the execution instruction is received (step S205). For example, such processing includes processing for converting all color image pages included in a manuscript into monochrome image pages, and the like.

After the processing of step S202 or step S205, the print processor 15a determines whether or not a printing instruction is received from the user through the input portion 11 (step S203).

When the printing instruction is received from the user (in the case of YES at step S203), the print processor 15a performs normal printing which does not involve page aggregate processing (step S204) and this normal print processing ends.

When the printing instruction is not received from the user within a predetermined time (in the case of NO at step S203), the job setting reception portion 17a cancels the setting of the job received at step S101 of FIG. 8 (step S206) and this normal print processing ends.

Next, description will be given for the aggregate print processing shown in step S107 of FIG. 8. FIG. 10 is a flowchart explaining an example of processing procedure of aggregate print processing.

First, the instruction reception portion 17b of the image formation device 10 determines whether or not the execution instruction of processing received from the user at step S104 of FIG. 8 is an instruction to modify arrangement sequence of pages such as insertion of a page (step S301).

When the execution instruction is not the instruction to modify arrangement sequence of pages (in the case of NO at step S301), the manuscript edit processor 17c executes the processing for which the execution instruction is received (step S310). For example, such processing includes processing for converting all color image pages included in a manuscript into monochrome image pages, and the like.

In addition, the print processor 15a determines whether or not a printing instruction is received from the user through the input portion 11 (step S308). When the printing instruction is received from the user (in the case of YES at step S308), the print processor 15a performs aggregate printing which involves page aggregate processing (step S309) and this normal print processing ends.

When the printing instruction is not received from the user within a predetermined time (in the case of NO at step S308), the job setting reception portion 17a cancels the setting of the job received at step S101 of FIG. 8 (step S312) and this normal print processing ends.

When the execution instruction of processing is the instruction to modify arrangement sequence of pages at step S301 (in the case of YES at step S301), the modification aggregation determination portion 17d reads, from the page attribute information 16b of the storage portion 16, attribute information of a page whose combination is to be modified in an aggregate page by modifying arrangement sequence of pages in accordance with the instruction to modify arrangement sequence of pages received at step S104 of FIG. 8 (step S302). Specifically, the modification aggregation determination portion 17d reads information of whether an image of the page whose combination is to be modified in the aggregate page is a color image or a monochrome image.

Thereafter, the modification aggregation determination portion 17d determines whether or not a color image page and a monochrome image page are intermixed in an aggregate page in which a combination of pages is to be modified (step S303).

When a color image page and a monochrome image page are intermixed in the above-described aggregate page (in the case of YES at step S303), the display controller 17e controls the display 12 to display the warning message 3 to warn that print processing for the aggregate page becomes monochrome printing as shown in FIG. 7 (step S304).

Thereafter, the instruction reception portion 17b determines whether or not inputting to permit the monochrome printing is received from the user within a predetermined time (step S305). Specifically, the instruction reception portion 17b determines whether or not the permission instruction reception area 3a shown in FIG. 7 is touched by the user within a predetermined time.

When inputting to permit the monochrome printing is not received from the user within a predetermined time (in the case of NO step S305), the manuscript edit processor 17c discards the instruction to modify arrangement sequence of pages received at step S104 (step S311).

Thereafter, the print processor 15a determines whether or not a printing instruction is received from the user through the input portion 11 within a predetermined time (step S308). When the printing instruction is received from the user within a predetermined time (in the case of YES at step S308), the print processor 15a generates an aggregate page and further executes print processing for the generated aggregate page (step S309), and this aggregate print processing ends.

When the printing instruction is not received from the user within a predetermined time at step S308 (in the case of NO at step S308), the job setting reception portion 17a cancels the setting of the job received at step S101 (step S312), and this aggregate print processing ends.

When a color image page and a monochrome image page are not intermixed in the aggregate page in which a combination of pages is to be modified at step S303 (in the case of NO at step S303), the modification aggregation determination portion 17d determines whether or not the intermixing determination processing of step S303 is completed for all the aggregate pages in which a combination of pages is to be modified (step S306).

When the intermixing determination processing is not completed for all the aggregate pages (in the case of NO at step S306), the procedure moves to step S302, and attribute information of pages whose combination is to be modified in an aggregate page for which the intermixing determination processing is not completed is read (step S302), and the subsequent processing is continued.

When the intermixing determination processing is completed for all the aggregate pages at step S306 (in the case of YES at step S306), the manuscript edit processor 17c modifies arrangement sequence of pages in accordance with the instruction to modify arrangement sequence of pages received at step S104 (step S307).

Thereafter, the print processor 15a determines whether or not a printing instruction is received from the user through the input portion 11 within a predetermined time (step S308). When the printing instruction is received from the user within a predetermined time (in the case of YES at step S308), the print processor 15a generates an aggregate page and further executes print processing for the generated aggregate page (step S309), and this aggregate print processing ends.

When the printing instruction is not received from the user within a predetermined time at step S308 (in the case of NO at step S308), the job setting reception portion 17a cancels the setting of the job received at step S101 (step S312), and this aggregate print processing ends.

Note that, in the above-described embodiment 1, when the user performs edit such as insertion of a page included in an aggregate page and a color image page and a monochrome image page become intermixed in the aggregate page, the image processing device displays the warning message to warn that the aggregate page is subjected to monochrome printing, but the image processing device may prohibit edit which results in intermixing of a color image page and a monochrome image page.

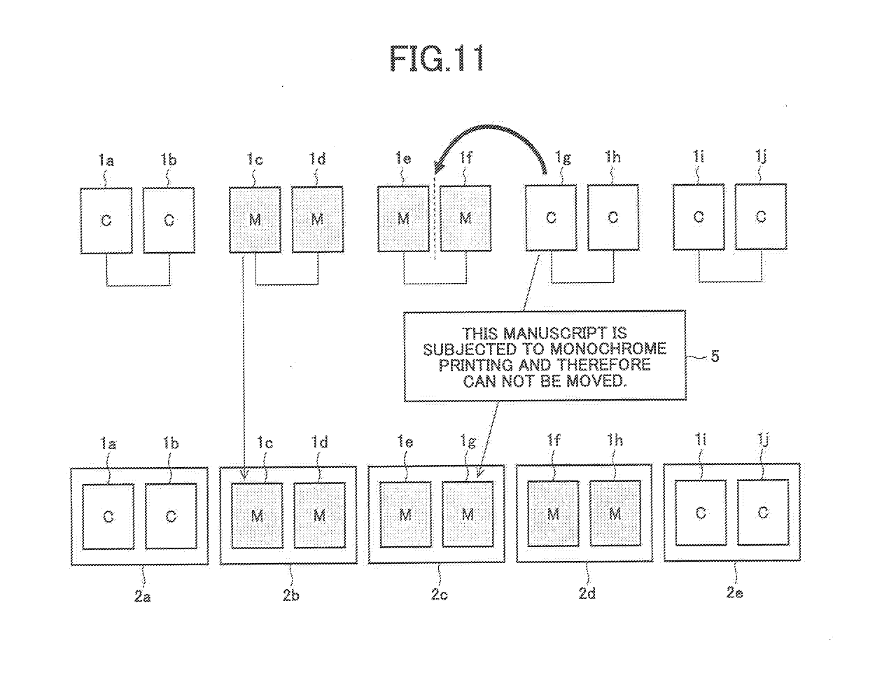

FIG. 11 is a view explaining an example of prohibition processing of page edit processing. In FIG. 11, shown is a case where the page 1g is inserted ahead of the page 1f. In the touch panel of the image formation device, icons corresponding to each of the pages 1a to 1j shown in FIG. 11 are displayed in page number sequence as a preview screen, and the user instructs the image formation device to execute insertion processing of the page 1g by dragging the page 1g in the touch panel to insert the page 1g ahead of the page 1f.

Similarly to the case of FIG. 1, when pages to be aggregated after the page 1g is inserted are all color image pages (page 1a and page 1b, page 1i and page 1j), the image formation device generates aggregate pages of the color images (aggregate pages 2a, 2e).

Moreover, when pages to be aggregated are all monochrome image pages (page 1c and page 1d), the image formation device generates an aggregate page of the monochrome image (aggregate page 2b).

Here, when the page 1g is inserted ahead of the page 1f to modify arrangement sequence of the pages 1f to 1j, the modification aggregation determination portion 17d of the image processing device 10 determines whether or not the modification to the arrangement sequence results in intermixing of a color image page and a monochrome image page in the same aggregate page.

In the example of FIG. 11, the color image page 1g and the monochrome image page 1e become intermixed in the aggregate page 2c, resulting that the page 1g is subjected to monochrome printing, and therefore the image processing device displays a warning message 5 to the effect that insertion processing of the page 1g is prohibited. In addition, even if printing of the page 1g does not become monochrome printing, when printing of the subsequent page is turned from color printing to monochrome printing by insertion of the page 1g, the image processing device displays the warning message 5 to the effect that insertion processing of the page 1g is prohibited.

Thereby, when the user performs insertion of a page, it is possible to notify the user that insertion of the page is prohibited because of intermixing of a color image page and a monochrome image page in an aggregate page, and to effectively assist edit working by the user.

Moreover, in the above-described embodiment 1, when a color image page and a monochrome image page are intermixed in an aggregate page, the aggregate page is subjected to monochrome printing, but the aggregate page may be subjected to color printing. In this case, the display controller 17e causes the display 12 to display a warning message to warn that the aggregate page is subjected to color printing.

Moreover, in the above-described embodiment 1, though description has been given for the case where arrangement sequence of pages is modified by inserting a page in the preview screen, the present invention is also applicable in the same manner when arrangement sequence of pages is modified by deleting a page in the preview screen.

In this case, the display 11 of the image formation device 10 arranges icons of each page included in a manuscript in page number sequence and further displays a preview screen in which a delete button for receiving an execution instruction of page deletion processing is arranged. By touching an icon of a page which is desired to be deleted and further touching the delete button, the user is able to instruct the image formation device 10 to delete the page.

The manuscript edit processor 17c of the image processing device 10 then deletes the page specified by the user and performs processing for modifying arrangement sequence of pages by moving up a page number of a page which follows the deleted page.

Further, when aggregate printing is performed, the modification aggregation determination portion 17d determines whether or not the above-described modification to the arrangement sequence results in intermixing of a color image page and a monochrome image page in the same aggregate page. Subsequently, similarly to the case of FIG. 2, when it is determined that a color image page and a monochrome image page are intermixed in the same aggregate page, the display controller 17e causes the display 11 to display the warning message 3 to the effect that print processing becomes monochrome printing.

In this manner, even when the user performs deletion of a page included in an aggregate page, it is possible to notify the user that print processing becomes monochrome printing and to effectively assist page edit working by the user.

Moreover, in the above-described embodiment 1, though a warning message is displayed when a color image page and a monochrome image page are intermixed in an aggregate page, the present invention could be also applied in the same manner to a case where a page attribute other than the attribute including a color image or a monochrome image is used.

For example, in such a case where pages with different image formats are intermixed in an aggregate page and the format of each page is converted into any of the formats, the image formation device may display a warning message.

Moreover, in such a case where an output color is set so as to perform color printing or monochrome printing for each page, pages with different output colors are intermixed in an aggregate page, and the output color of each page is converted into any of the output colors, the image formation device may display a warning message.

In addition, in such a case where pages with different gradation are intermixed in an aggregate page and the gradation of each page is converted into any of the gradations, a warning message may be displayed. For example, in such a case where a page of an image with gradation of 2 and a page of an image with gradation of 8 are intermixed in an aggregate page and the gradation of each page is converted into the gradation of 2, the image formation device may display a warning message.

### Embodiment 2

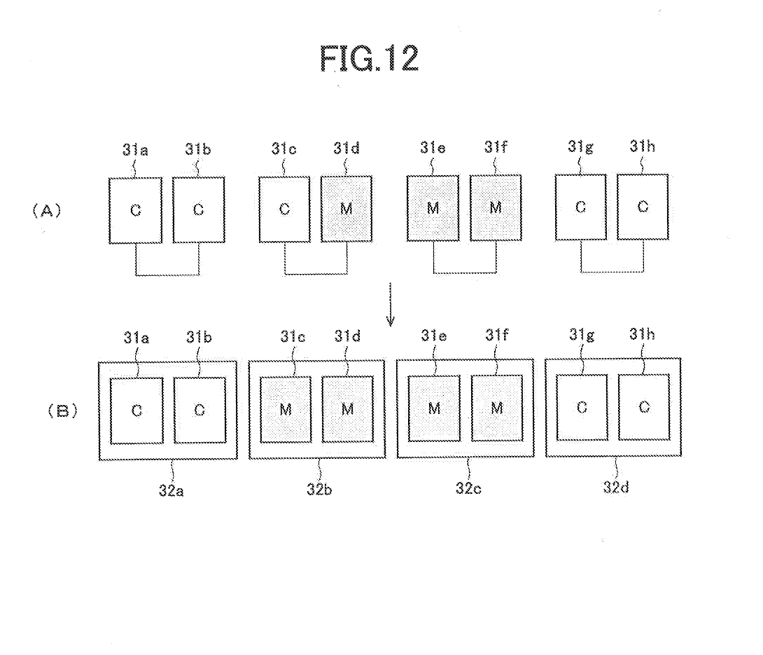

Description will hereinafter be given specifically for an embodiment 2 of the present invention with reference to drawings. First, description will be given for image formation processing according to the embodiment 2 of the present invention. FIG. 12 is a view explaining an example of page aggregate processing according to the embodiment 2 of the present invention.

In FIG. 12(A), respective pages 31a to 31h of manuscript images read by an image formation device in sequence are shown. A mark of “C” assigned to a page shows that the page is a color image, and a mark of “M” shows that the page is a monochrome image. In addition, in a touch panel of the image formation device, icons corresponding to each of the pages 31a to 31h shown in FIG. 12(A) are displayed in page number sequence as a preview screen. Here, the icon is such that images of each of the pages 31a to 31h of the manuscript image and each of the aggregate pages 32a to 32d are reduced to display each image and each aggregate page so as to be visible.

Moreover, the image formation device is a device which forms an image, such as an MFP (Multifunction Peripheral), a printer, a copier or a facsimile. Description will be given below for a case where the image formation device is an MFP.

This image formation device is provided with an aggregate copy function for aggregating a plurality of pages included in a manuscript read by scanning to one page for printing (N in 1 copy: N is a natural number of 2 and above). In this aggregate copy, an aggregate page in which the plurality of pages which are read are aggregated into one page is generated and the generated aggregate page is printed.

In FIG. 12(B), an example of each of the aggregate pages 32a to 32d that two pages are aggregated into one page is shown. Note that, description will be given below for a case where 2 in 1 copy is performed, but without limitation thereto, the present invention is also applicable to other aggregate copy such as 4 in 1 copy.

When scanning a manuscript, this image formation device determines whether each page included in the manuscript is a color image page or a monochrome image page, and registers the determination result as attribute information of each page. Then, the image formation device performs color printing for the color manuscript page and performs monochrome printing for the monochrome image page.

However, in a case where aggregate copy is performed when a color image page and a monochrome image page are intermixed in an aggregate page, the image formation device converts the color image page into a monochrome image page and generates an aggregate page which includes only monochrome image pages (aggregate page 32b of FIG. 12(B)) to perform monochrome printing for the generated aggregate page.

For example, in FIG. 12(A), when pages to be aggregated are all color image pages (page 31a and page 31b, page 31g and page 31h), the image formation device generates aggregate pages of the color images (aggregate pages 32a, 32d) as shown in FIG. 12(B).

Moreover, in FIG. 12(A), when pages to be aggregated are all monochrome image pages (page 31e and page 31f), the image formation device generates an aggregate page of the monochrome image (aggregate page 32c) as shown in FIG. 12(B).

Further, in FIG. 12(A), when pages to be aggregated include the color image page 31c and the monochrome image page 31d, the image formation device converts the color image page 31c into a monochrome image page to generate the aggregate page 32b which includes only monochrome image pages as shown in FIG. 12(B).

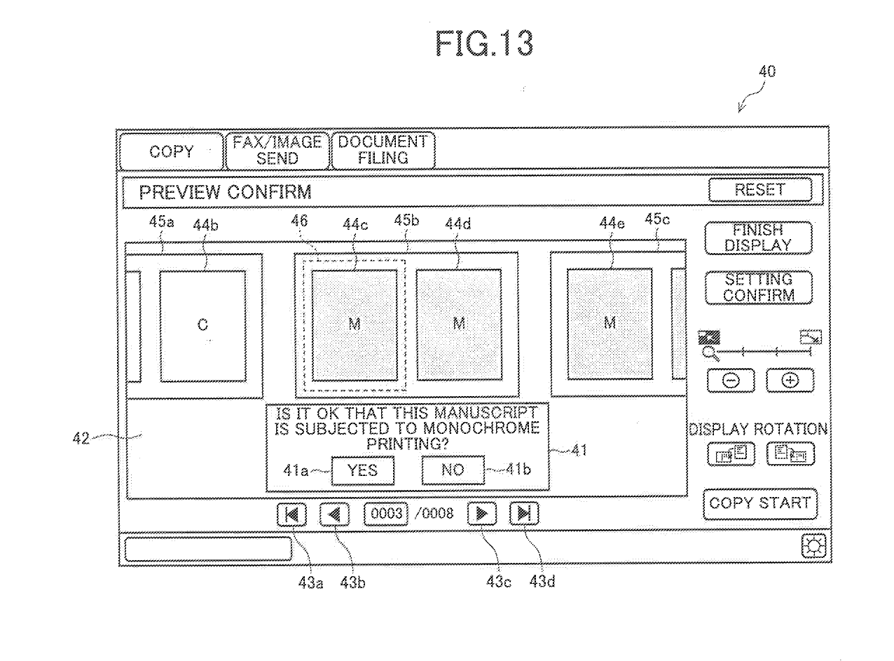

When the color image page is converted into the monochrome image page, the image formation device displays a warning message to the effect that the page 31c is subjected to monochrome printing. FIG. 13 is a view showing an example of a preview screen 40 in which a warning message 41 is displayed.

In this preview screen 40, a page display area 42 and go buttons 43a to 43d are displayed. In addition, in the page display area 42, icons 44b to 44e showing each page of manuscript targeted for aggregation, icons 45a to 45c showing aggregate pages in which each page is aggregated, the warning message 41, a permission instruction reception area 41a, and a prohibition instruction reception area 41b are displayed.

The go buttons 43a to 43d are buttons for scrolling display of the icons 44b to 44e. When the user touches the go buttons 43a to 43d, an icon which is not displayed in the page display area 42 becomes possible to be displayed.

Moreover, when the user drags the icons 44b to 44e to move the icons 44b to 44e outside the page display area 42, the page display area 42 is scrolled according to the movement, so that an icon which is not displayed in the page display area 42 becomes displayed.

By dragging any of the icons to insert the icon ahead of a different icon in this page display area 42, the user is able to instruct the image formation device to insert a page corresponding to the dragged icon ahead of a page corresponding to the different icon.

The permission instruction reception area 41a is a touch area for receiving, from the user, an instruction to permit that the page 31c shown in FIG. 12(A) indicated by the icon 44c is subjected to monochrome printing, and the prohibition instruction reception area 41b is a touch area for receiving, from the user, an instruction not to permit it.

When the user touches the permission instruction reception area 41a and thereafter a printing instruction of the aggregate pages 32a to 32d shown in FIG. 12(B) is received from the user, the image formation device performs printing of the aggregate pages 32a to 32d. In this case, the image formation device performs color printing for the aggregate pages 32a and 32d and performs monochrome printing for the aggregate pages 32b and 32c.

Note that, the icon 44c of the color image page 31c subjected to monochrome printing because of being aggregated is displayed in a form different from other icons 44b, 44d and 44e. For example, as shown in FIG. 13, the icon 44c is highlighted by being surrounded with a highlighting frame line 46 or the like. Here, the highlighting for the icon 44c may be blinking display or display using a color different from a display color of other icons.

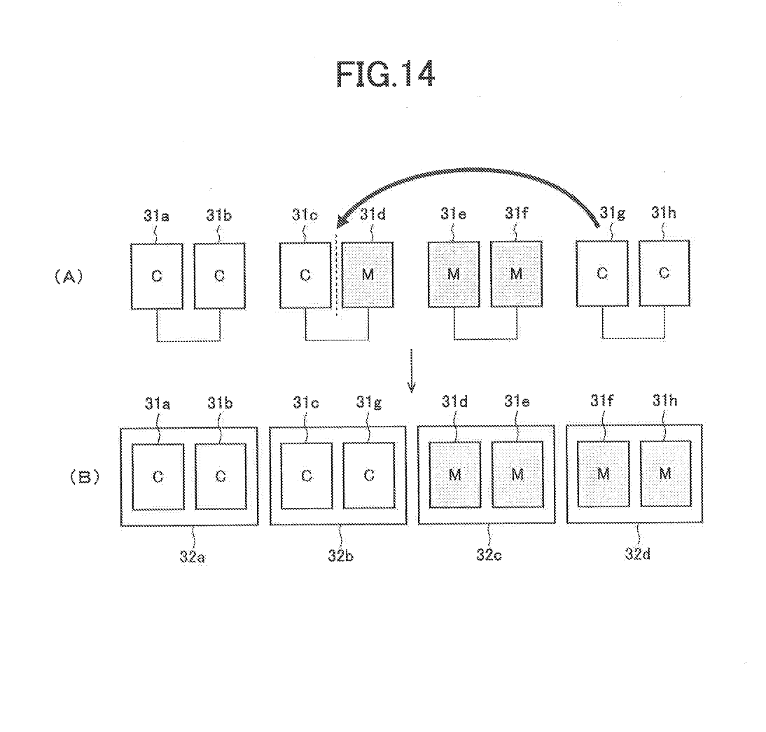

On the other hand, when the user does not desire that the page 31c is subjected to monochrome printing, the user is able to instruct the image formation device to modify arrangement sequence of pages. Specifically, by touching the prohibition instruction reception area 41b and thereafter performing page insertion on the touch panel, the user is able to modify arrangement sequence of pages. FIG. 14 is a view explaining an example of page aggregate processing when page insertion is performed.

In FIG. 14(A), shown is a case where the page 31g is inserted ahead of the page 31d. In this case, since the page 31c is to be aggregated with the page 31g which is the color image, the page 31c is subjected to color printing as shown in FIG. 14(B). However, since the monochrome image page 31f and the color image page 31h become intermixed in the aggregate page 32d and the page 31h is subjected to monochrome printing, the image formation device displays a warning message to the effect that the page 31h is subjected to monochrome printing.

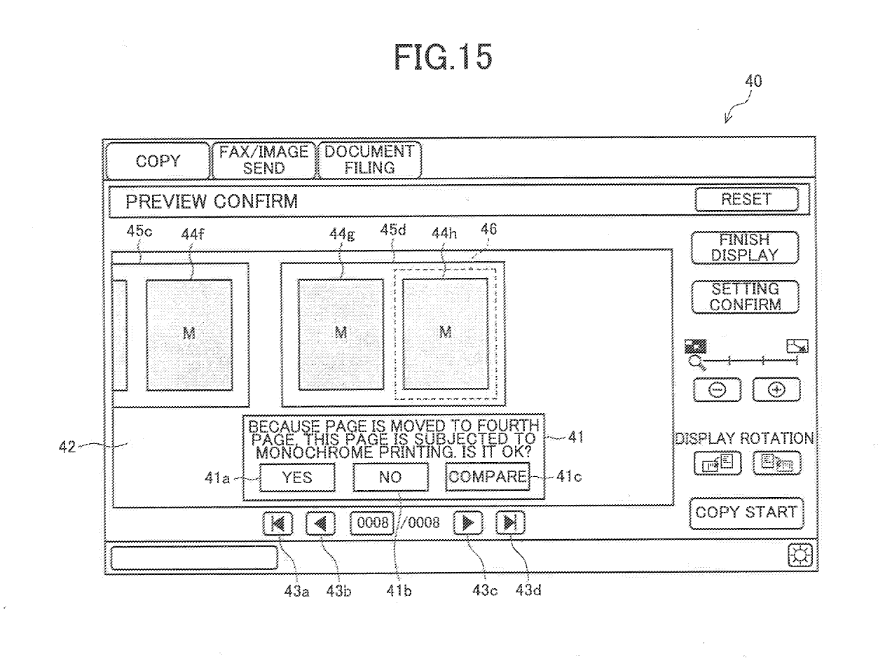

FIG. 15 is a view showing another example of the preview screen 40 in which the warning message 41 is displayed. Similarly to the preview screen 40 shown in FIG. 13, the page display area 42 and the go buttons 43a to 43d are displayed in this preview screen 40. In addition, in the page display area 42, icons 44f to 44h showing each page, icons 45c and 45d showing aggregate pages, the warning message 41 showing that the page 31h corresponding to the icon 44h is subjected to monochrome printing, the permission instruction reception area 41a, the prohibition instruction reception area 41b, and a comparison instruction reception area 41c are displayed.

Further, when the user touches the permission instruction reception area 41a and thereafter a printing instruction of the aggregate pages 32a to 32d is received from the user, the image formation device performs printing of the aggregate pages 32a to 32d. In this case, the image formation device performs color printing for the aggregate pages 32a and 32b and performs monochrome printing for the aggregate pages 32c and 32d as shown in FIG. 14(B).

On the other hand, when the user touches the prohibition instruction reception area 41b, the image formation device cancels insertion processing of the page 31g. When a printing instruction is received from the user, the image formation device then executes printing of an aggregate page in which pages are aggregated in the original arrangement sequence before insertion of the page 31g.

Note that, insertion processing of the page 31g may be executed without cancelling the insertion processing so as to perform color printing for the aggregate page 32d including the page 31h. In this case, since printing of the page 31f which is the monochrome image becomes color printing, the image formation device may display a warning message to the effect that the page 31f is subjected to color printing.

Moreover, when the user touches the comparison instruction reception area 41c, the image formation device displays both aggregate pages in page number sequence before page insertion and aggregate pages in page number sequence after page insertion in the preview screen 40.

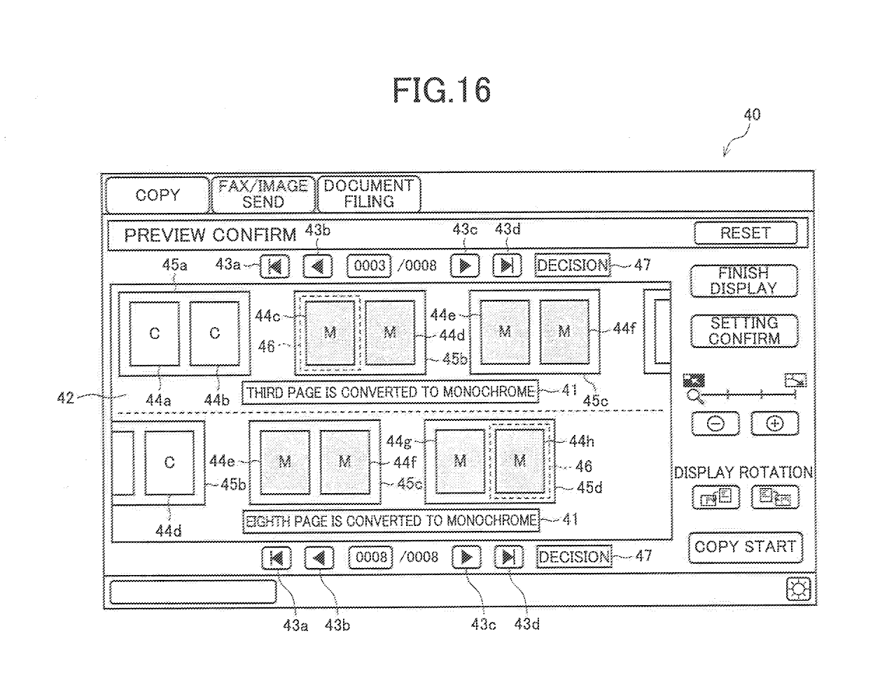

FIG. 16 is a view showing an example of the preview screen 40 in which icons 44a to 44h of pages before and after page insertion are displayed. In the upper row of the page display area 42 of FIG. 16, icons 44a to 44f showing each page of manuscript targeted for aggregation that are arranged in page number sequence before page insertion and the warning message 41 are displayed, and in the lower row of the page display area 42, icons 44d to 44h showing each page of manuscript targeted for aggregation that are arranged in page number sequence after page insertion and the warning message 41 are displayed,

Moreover, the image formation device displays a page number sequence enter button 47 in the preview screen 40 and receives, from the user, selection of whether to print each page in page number sequence before page insertion or print each page in page number sequence after page insertion. The image formation device then performs printing of the aggregate pages 32a to 32d in the selected page number sequence.

In other words, when the user selects to print each page in page number sequence before page insertion, the image formation device prints the aggregate pages 32a to 32d shown in FIG. 12(B), and when the user selects to print each page in page number sequence after page insertion, prints the aggregate pages 32a to 32d shown in FIG. 14(B).

As described above, since the image formation device receives, from the user, a modification instruction for instructing to insert an icon corresponding to a page included in a manuscript targeted for formation of an aggregate page ahead of an icon corresponding to another page of the manuscript to modify arrangement sequence of each page, when the user performs page edit, it is possible to notify the user that print processing of the page becomes monochrome printing and to effectively assist page edit working by the user.

In addition, the image formation device determines, as to an aggregate page which includes a first page among pages whose arrangement sequence is modified, whether or not a page with a different attribute (color image or monochrome image) is to be intermixed in the aggregate page as well as determines, as to a different aggregate page which includes a second page which follows the first page, whether or not a page with a different attribute is to be intermixed in the different aggregate page, so that it is possible to give the user a warning not only as to the aggregate page in which a page is inserted but also for other page affected by insertion of the page, and to effectively assist page edit working by the user.

Moreover, attribute information is information of whether an image of each page is a color image or a monochrome image, and when it is determined that a color image page and a monochrome image page are to be intermixed in the same aggregate page, the image formation device displays a message for notifying that a color aggregate page is formed or a monochrome aggregate page is formed as a warning message, thus making it possible to give an appropriate warning to the user and to effectively assist page edit working by the user.

In addition, since the image formation device displays a page with a different attribute in a different form by performing emphasis display or the like in the preview screen, the user is able to easily recognize for which page the warning message is displayed.

Further, when it is determined that pages with a different attribute are to be intermixed in the same aggregate page, the image formation device displays a preview screen in which icons are arranged in arrangement sequence before modification and arrangement sequence after modification, so that the user is able to easily understand that what aggregate page is formed in arrangement sequence before modification and in arrangement sequence after modification.

Moreover, the image formation device receives any one of selections of the arrangement sequence before modification and the arrangement sequence after modification and forms an aggregate page in the selected arrangement sequence, thus making it possible to easily form the aggregate page desired by the user.

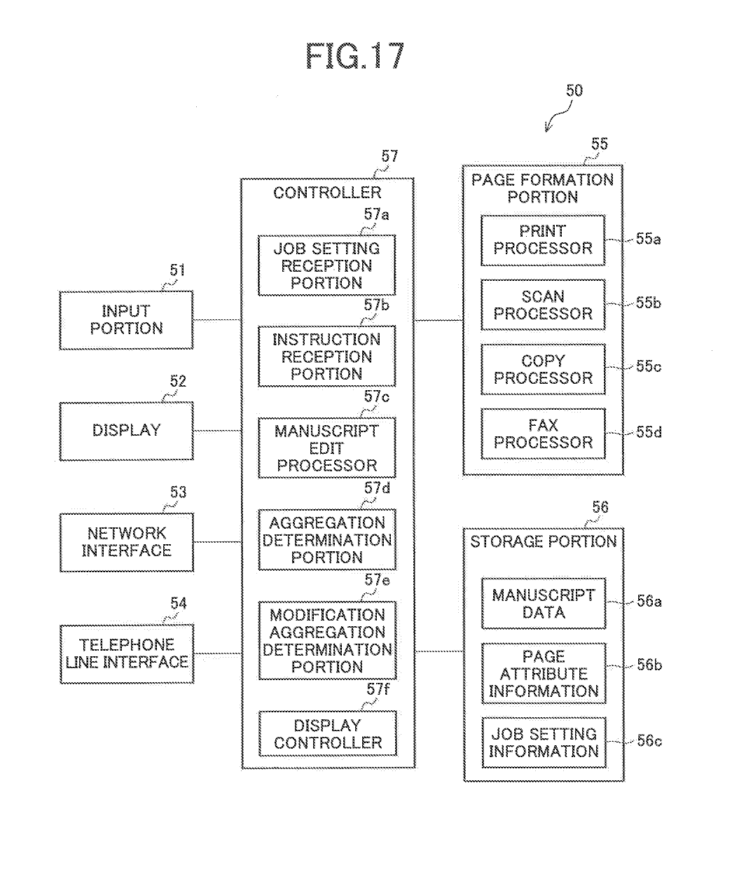

Next, description will be given for a functional structure of an image formation device 50 according to the embodiment 2 of the present invention. FIG. 17 is a block diagram showing an example of a functional structure of the image formation device 50 according to the embodiment 2 of the present invention. This image formation device 50 is provided with an input portion 51, a display 52, a network interface 53, a telephone line interface 54, a page formation portion 55, a storage portion 56 and a controller 57.

The input portion 51 is an input device consisting of a touch pad and the like. The display 52 is a display device consisting of a liquid crystal panel and the like. The input portion 51 and the display 52 constitute the touch panel in combination with each other.

The network interface 53 is a processor which performs communication with other communication device through a network such as a LAN (Local Area Network). The telephone line interface 54 is a processor which performs communication with other device such as a Fax device through a telephone line.

The page formation portion 55 is a processor which executes various image formation processing. This page formation portion 55 is provided with a print processor 55a, a scan processor 55b, a copy processor 55c, and a Fax processor 55d.

The print processor 55a is a processor which performs print processing of manuscript data. For example, at the time of aggregate copy, when pages aggregated into one page are all color images, the print processor 55a generates image data of an aggregate page of the color image and performs color printing of the generated image data. In addition, when pages aggregated into one page are all monochrome images, the print processor 55a generates image data of an aggregate page of the monochrome image and performs monochrome printing of the generated image data.

Further, when pages aggregated into one page include both color image page and monochrome image page, the print processor 55a converts the color image page into a monochrome image page and generates image data of an aggregate page which includes only monochrome image pages to perform monochrome printing of the generated image page.

The scan processor 55b is a processor which performs scan processing of manuscript. After executing scan processing of manuscript, this scan processor 55b performs processing for determining whether image data obtained by scan processing is a color image or a monochrome image, processing for allocating a page number to the image data, and the like.

The copy processor 55c is a processor which performs copy processing of manuscript data. When performing copy processing, the copy processor 55c requests the scan processor 55b to scan manuscript, and requests the print processor 55a to print the resulting image data. The Fax processor 55d is a processor which performs Fax transmission/reception processing.

The storage portion 56 is a storage device such as a memory or a hard disc device. This storage portion 56 stores data such as manuscript data 56a, page attribute information 56b and job setting information 56c.

The manuscript data 56a is image data of manuscript read by the scan processor 55b and image data of Fax received by the Fax processor 55d.

The page attribute information 56b is attribute information of each page in which image data is stored as the manuscript data 56a. Specifically, the page attribute information 56b includes information of whether image data of each page stored as the manuscript data 56a is a color image or a monochrome image, information of a page number of each page, and the like.

The job setting information 56c is setting information of a job inputted by operating the input portion 51 by the user. For example, the job setting information 56c includes information of whether or not to perform page aggregation, information of the number of pages to be included in one page when page aggregation is performed, information for, when a page of different manuscript from manuscript to be copied is inserted to perform page edit, specifying the different manuscript, and the like.

The controller 57 is a controlling device such as a CPU (Central Processing Unit) which controls each functional portion of the image formation device 50. This controller 57 is provided with a job setting reception portion 57a, an instruction reception portion 57b, a manuscript edit processor 57c, an aggregation determination portion 57d, a modification aggregation determination portion 57e, and a display controller 57f.

The job setting reception portion 57a is a processor which receives setting information of a job from the user through the input portion 51. The job setting reception portion 57a stores the received setting information in the storage portion 56 as the job setting information 56c.

The instruction reception portion 57b is a processor which receives an instruction to edit manuscript to be printed from the user through the input portion 51. For example, the instruction reception portion 57b receives an instruction to modify arrangement sequence of pages by page insertion or the like from the user. The manuscript edit processor 57c is a processor which performs processing for editing manuscript to be printed in accordance with the edit instruction received by the instruction reception portion 57b.

The aggregation determination portion 57d is a processor which, when an aggregate page is printed in the original page number sequence of each page included in a manuscript to be printed, determines whether or not a color image page and a monochrome image page are to be intermixed in the same aggregate page.

The modification aggregation determination portion 57e is a processor which, when the instruction reception portion 57b receives an instruction to modify arrangement sequence of pages from the user and an aggregate page is printed in page number sequence after the modification, determines whether or not the modification to the arrangement sequence results in intermixing of a color image page and a monochrome image page in the same aggregate page.

The display controller 57f is a processor which controls display of information on the display 52. For example, when it is determined by the aggregation determination portion 57d or the modification aggregation determination portion 57e that a color image page and a monochrome image page are to be intermixed in the same aggregate page, the display controller 57f controls the display 52 to cause the display 52 to display the warning message 41 as shown in FIGS. 13, 15 and 16.

Moreover, the display controller 57f controls the display 52 to cause the display 52 to display the preview screen 40 as shown in FIG. 16 for receiving, from the user, selection of whether to print each page in page number sequence before page insertion or print each page in page number sequence after page insertion.

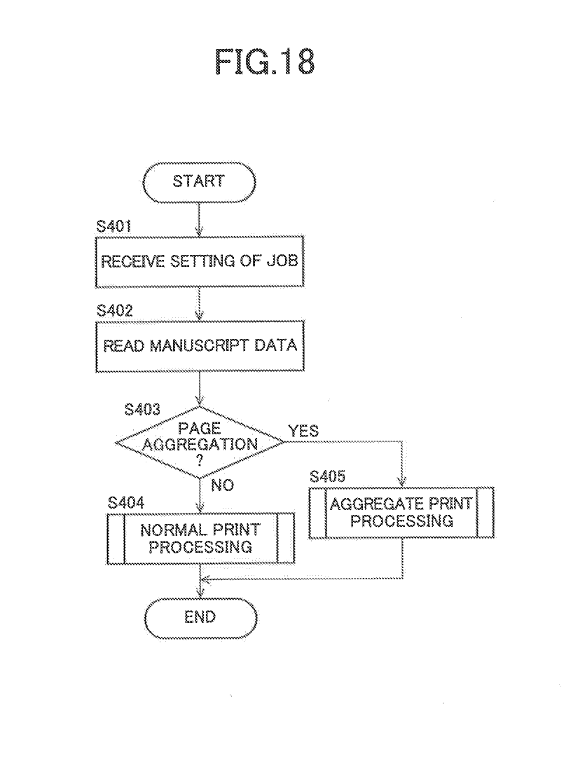

Next, description will be given for processing procedure of image formation processing according to the embodiment 2 of the present invention. FIG. 18 is a flowchart showing an example of processing procedure of image formation processing according to the embodiment 2 of the present invention.

First, the job setting reception portion 57a of the image formation device 50 receives inputting of job setting information from the user through the input portion 51 (step S401). The job setting information is information of whether or not to perform page aggregation, information of the number of pages to be included in one page when page aggregation is performed, and the like.

The display controller 57f then reads the manuscript data 56a from the storage portion 56 (step S402). Thereafter, the aggregation determination portion 57d refers to the setting information of the job inputting of which is received at step S401 to determine whether or not it is set to perform page aggregation in the setting information (step S403).

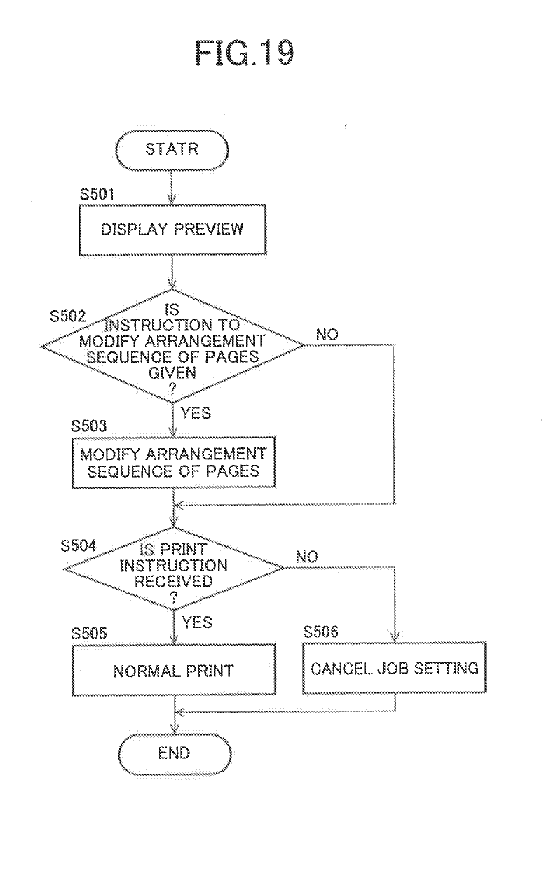

When it is not set to perform page aggregation in the setting information (in the case of NO at step S403), the display controller 57f and the print processor 55a execute normal print processing which does not involve page aggregation (step S404). This normal print processing will be explained specifically below with the use of FIG. 19.

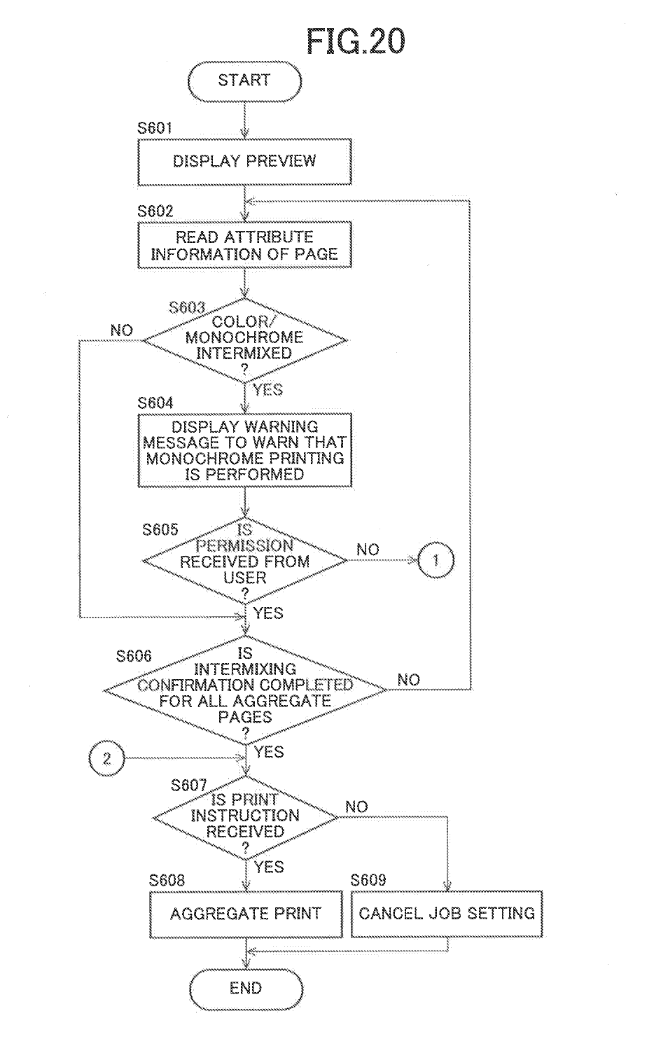

When it is set to perform page aggregation in the setting information (in the case of YES at step S403), the aggregation determination portion 57d, the modification aggregation determination portion 57e, the display controller 57f and the print processor 57a execute aggregate print processing which involves page aggregation (step S405). This aggregate print processing will be explained specifically below with the use of FIGS. 20 to 22.

After the normal print processing of step S404 or the aggregate print processing of step S405, this image formation processing ends.

Next, description will be given for the normal print processing shown in step S404 of FIG. 18. FIG. 19 is a flowchart explaining an example of processing procedure of normal print processing.

First, on the basis of the manuscript data 56a stored in the storage portion 56, the display controller 57f of the image formation device 50 generates image data of a preview screen in which each page of manuscript to be printed is displayed being arranged in page number sequence, and controls the display 52 to cause the display 52 to display the generated preview screen (step S501).

The instruction reception portion 57b then determines whether or not an instruction to modify arrangement sequence of pages is received from the user through the input portion within a predetermined time (step S502). When the instruction to modify arrangement sequence of pages is received from the user within a predetermined time (in the case of YES at step S502), the manuscript edit processor 57c modifies arrangement sequence of pages in accordance with the modification instruction (step S503).

After the processing of step S503 or when the instruction to modify arrangement sequence of pages is not received from the user within a predetermined time at step S502 (in the case of NO at step S502), the instruction reception portion 57b determines whether or not a printing instruction is received from the user through the input portion 51 within a predetermined time (step S504).

When the printing instruction is received from the user within a predetermined time (in the case of YES at step S504), the print processor 55a performs normal print which does not involve page aggregate processing (step S505), and this normal print processing ends.

When the print processing is not received from the user within a predetermined time (in the case of NO at step S504), the job setting reception portion 57a cancels the setting of the job received at step S401 of FIG. 18 (step S506), and this normal print processing ends.

Next, description will be given for the aggregate print processing shown in step S405 of FIG. 18. FIGS. 20 to 22 are flowcharts explaining an example of processing procedure of aggregate print processing.

First, on the basis of the manuscript data 56a stored in the storage portion 56, the display controller 57f of the image formation device 50 generates image data of a preview screen in which each page of manuscript to be printed is displayed being arranged in page number sequence, and controls the display 52 to cause the display 52 to display the generated preview screen (step S601).

The aggregation determination portion 57d then reads, from the page attribute information 56b of the storage portion 56, attribute information of each page included in an aggregate page (step S602). Specifically, the aggregation determination portion 57d reads information of whether an image of each page included in the above-described aggregate page is a color image or a monochrome image.

Thereafter, the aggregation determination portion 57d determines whether or not a color image page and a monochrome image page are intermixed in an aggregate page generated by arranging each page of the manuscript in page number sequence (step S603).

When a color image page and a monochrome image page are intermixed in the aggregate page (in the case of YES at step S603), the display controller 57f then controls the display 52 to cause the display 52 to display the warning message 41 to warn that print processing of the aggregate page becomes monochrome printing like in the preview screen 40 shown in FIG. 13 (step S604).

Subsequently, the instruction reception portion 57b determines whether or not inputting to permit that the print processing of the above-described aggregate page becomes monochrome printing is received from the user within a predetermined time (step S605). Specifically, the instruction reception portion 57b determines whether or not the permission instruction reception area 41a shown in FIG. 13 is touched by the user within a predetermined time.

When the permission instruction reception area 41a is touched by the user within a predetermined time (in the case of YES at step S605) or when a color image page and a monochrome image page are not intermixed in the above-described aggregate page (in the case of NO at step S603), the aggregation determination portion 57d determines whether or not the intermixing determination processing of step S603 is completed for all the aggregate pages (step S606).

When the intermixing determination processing is not completed for all the aggregate pages (in the case of NO at step S606), the procedure moves to step S602, and the aggregation determination portion 57d reads attribute information of each page included in an aggregate page for which the intermixing determination processing is not completed from the page attribute information 56b of the storage portion 56 (step S602), and the subsequent processing is continued.

When the intermixing determination processing is completed for all the aggregate pages (in the case of YES at step S606), the print processor 55a determines whether or not a printing instruction is received from the user through the input portion 51 within a predetermined time (step S607).

When the printing instruction is received from the user within a predetermined time (in the case of YES at step S607), the print processor 55a generates an aggregate page and further executes print processing for the generated aggregate page (step S608), and this aggregate print processing ends.

When the printing instruction is not received from the user within a predetermined time at step S607 (in the case of NO at step S607), the job setting reception portion 57a cancels the setting of the job received at step S401 of FIG. 18 (step S609), and this aggregate print processing ends.

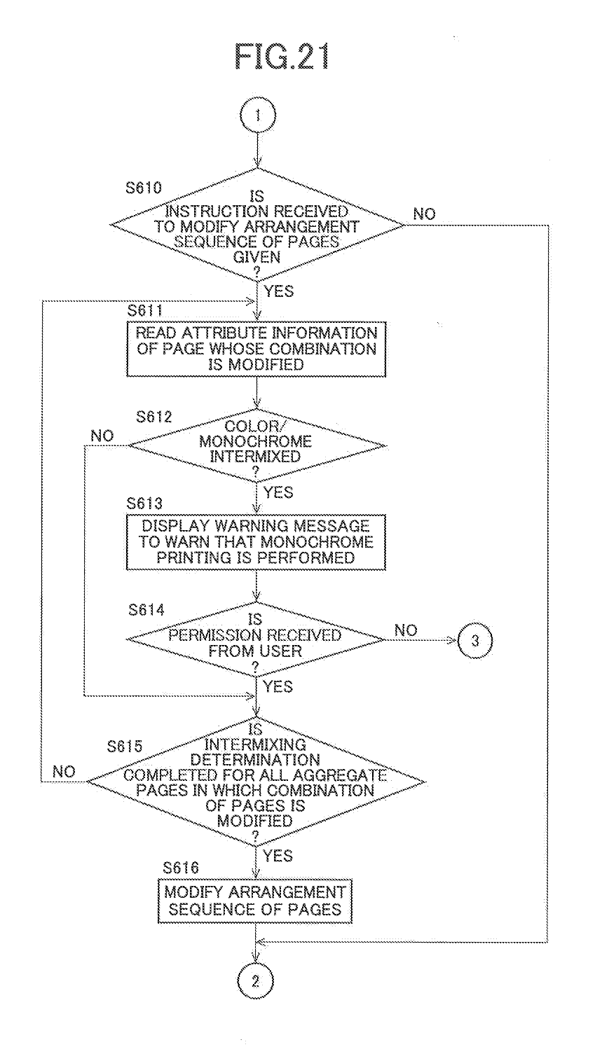

When inputting to permit that print processing of the aggregate page becomes monochrome printing is not received from the user within a predetermined time at step S605 (in the case of NO at step S605), the instruction reception portion 57b determines whether or not an instruction to modify arrangement sequence of pages is received from the user through the input portion 51 within a predetermined time as shown in FIG. 21 (step S610).

When the instruction to modify arrangement sequence of pages is received from the user within a predetermined time (in the case of YES at step 610), the modification aggregation determination portion 57e reads, from the page attribute information 56b of the storage portion 56, attribute information of a page whose combination is modified in the aggregate page because arrangement sequence of pages is modified in accordance with the modification instruction.

Specifically, the modification aggregation determination portion 57e reads information of whether the images of the pages whose combination is modified in the aggregate page is a color image or a monochrome image. In the example of FIG. 14, when the page 31g is inserted between the page 31c and the page 31d, a combination of pages included in the aggregate page is modified in the aggregate pages 32b, 32c and 32d, so that, for example, information of whether images of the page 31c and the page 31g included in the aggregate page 32b are color images or monochrome images is read.

Thereafter, the modification aggregation determination portion 57e determines whether or not a color image page and a monochrome image page are intermixed in an aggregate page in which a combination of pages is to be modified (step S612).

When a color image page and a monochrome image page are intermixed in the above-described aggregate page (in the case of YES at step S612), the display controller 57f controls the display 52 to cause the display 52 to display the warning message 41 to warn that print processing of the aggregate page becomes monochrome printing like in the preview screen 40 shown in FIG. 15 (step S613).

Thereafter, the instruction reception portion 57b determines whether or not inputting to permit that the print processing of the above-described aggregate page becomes monochrome printing is received from the user within a predetermined time (step S614). Specifically, the instruction reception portion 57b determines whether or not the permission instruction reception area 41a shown in FIG. 15 is touched by the user within a predetermined time.

When the permission instruction reception area 41a is touched by the user within a predetermined time (in the case of YES at step S614) or when a color image page and a monochrome image page are not intermixed in the above-described aggregate page (in the case of NO at step S612), the modification aggregation determination portion 57e determines whether or not the intermixing determination processing of step S612 is completed for all the aggregate pages in which a combination of pages is to be modified (step S615).

When the intermixing determination processing is not completed for all the aggregate pages in which a combination of pages is to be modified (in the case of NO at step S615), the procedure moves to step S611, and the modification aggregation determination portion 57e reads, from the page attribute information 56b of the storage portion 56, attribute information of each page included in an aggregate pages for which the intermixing determination processing is not completed (step S611), and the subsequent processing is continued.

When the intermixing determination processing is completed for all the aggregate pages in which a combination of pages is to be modified (in the case of YES at step S615), the manuscript edit processor 57c modifies arrangement sequence of pages in accordance with the instruction to modify arrangement sequence of pages received at step S610 (step S616). Then, the procedure moves to step S607 of FIG. 20, and the subsequent processing is continued.

When the instruction to modify arrangement sequence of pages is not received within a predetermined time at step S610 (in the case of NO at step 610), without modifying arrangement sequence of pages, the procedure moves to step S607 of FIG. 20, and the subsequent processing is continued.

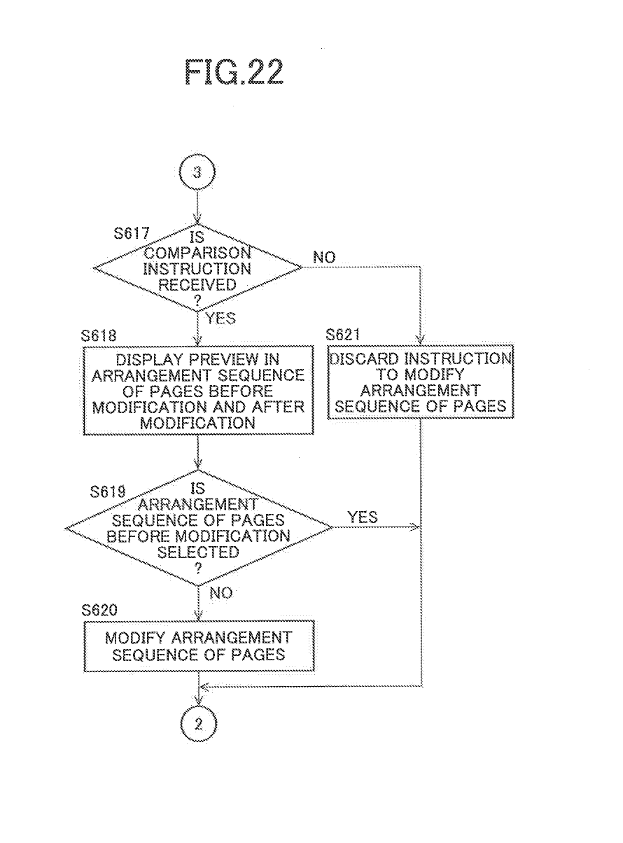

When inputting to permit that print processing of the above-described aggregate page becomes monochrome printing is not received from the user within a predetermined time at step S614 (in the case of NO at step S614), the instruction reception portion 57b determines whether or not a comparison instruction to compare arrangement sequence of pages before and after modification is received as shown in FIG. 22 (step S617). Specifically, the instruction reception portion 57b determines whether or not the comparison instruction reception area 41c shown in FIG. 15 is touched by the user within a predetermined time.

When the comparison instruction reception area 41c is touched by the user within a predetermined time (in the case of YES at step S617), on the basis of the manuscript data 56a stored in the storage portion 56, the display controller 57f generates image data of the preview screen 40 in which the status of each page before and after the modification to the arrangement sequence of pages is displayed side by side as shown in FIG. 16, and controls the display 52 to cause the display 52 to display the generated preview screen 40 (step S618).

The instruction reception portion 57b then receives either of selections of the arrangement sequence of pages before and after modification from the user through the input portion 51, and further determines whether or not the arrangement sequence of pages before modification is selected (step S619). Specifically, the instruction reception portion 57b determines whether or not the page number sequence enter button 47 which is displayed in a part where each page is displayed in the arrangement sequence of pages before modification among two page number sequence enter buttons 47 shown in FIG. 16 is touched by the user within a predetermined time.

When the arrangement sequence of pages before modification is selected (in the case of YES at step S619), without modifying the arrangement sequence of pages, the procedure moves to step S607 of FIG. 20, and the subsequent processing is continued.

When the arrangement sequence of pages after modification is selected by touching the page number sequence enter button 47 displayed in a part where each page is displayed in the arrangement sequence of pages after modification by the user within a predetermined time (in the case of NO at step S619), the manuscript edit processor 57c modifies the arrangement sequence of pages in accordance with the instruction to modify the arrangement sequence of pages received at step S610 of FIG. 21 (step S620). The procedure then moves to step S607 of FIG. 20, and the subsequent processing is continued.

When the comparison instruction to compare the arrangement sequence of pages before and after modification is not received within a predetermined time at step S617 (in the case of NO at step S617), the manuscript edit processor 57c discards the instruction to modify the arrangement sequence of pages received at step S610 of FIG. 21 so as not to perform the modification to the arrangement sequence of pages (step S621). The procedure then moves to step S607 of FIG. 20, and the subsequent processing is continued.

Note that, modification to the arrangement sequence of pages in the above-describe embodiment 2 is by, but not limited to, moving pages in the same manuscript as shown in FIG. 14. For example, the present invention could be also applied when arrangement sequence of pages is modified by inserting a page included in different manuscript.

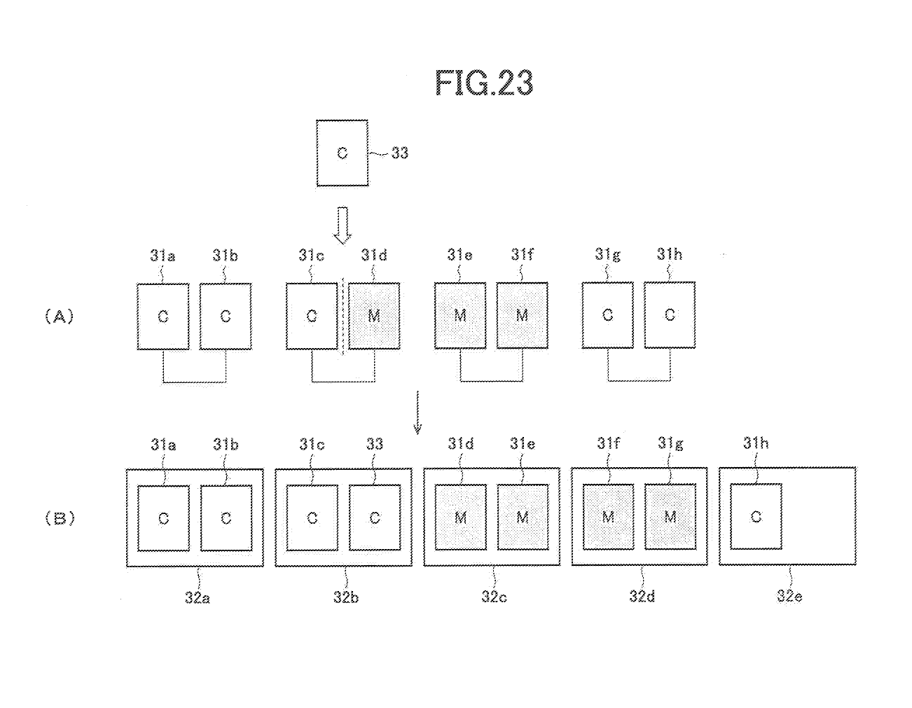

FIG. 23 is a view explaining an example of page aggregate processing when a page included in different manuscript is inserted. In FIG. 23(A), shown is a case where a page 33 which is read from manuscript different from the manuscript which includes pages 31a to 31h is inserted between the page 31c and the page 31d.

In this case, the display controller 57f controls the display 52 to cause the display 52 to display a preview screen in which icons corresponding to each of the pages 31a to 31h of the manuscript are arranged in page number sequence as well as icons corresponding to each page of the different manuscript are arranged in page number sequence.

Then, by dragging the icon corresponding to the page 33 among the icons corresponding to each page of the different manuscript to insert the icon between the icon corresponding to the page 31c and the icon corresponding to the page 31d, the user is able to instruct the image formation device to insert the page 33 between the page 31c and the page 31d.

In this page aggregate processing, the aggregation determination portion 57d firstly determines, when each page included in a manuscript is aggregated being arranged in page number sequence, whether or not a color image page and a monochrome image page are to be intermixed in the same aggregate page. When a color image page and a monochrome image page are to be intermixed in the same aggregate page, the display controller 57f then controls the display 52 to cause the display 52 to display a warning message to the effect that an aggregate page in which a color image page and a monochrome image page are intermixed is subjected to monochrome printing, similarly to the case explained in FIG. 13.

In the example of FIG. 23(A), when each of the pages 31a to 31h included in a manuscript is arranged in its page number sequence, the page 31c and the page 31d are to be intermixed in the same aggregate page, so that the display controller 57f causes the display 52 to display a warning message similar to the warning message 41 shown in FIG. 13.

When the permission instruction reception area 41a as shown in FIG. 13 is touched by the user and thereafter a printing instruction of aggregate pages is received from the user, the print processor 55a performs printing of the aggregate pages in which the page 31a and the page 31b, the page 31c and the page 31d, the page 31e and the page 31f, and the page 31g and the page 31h are aggregated, respectively as shown in FIG. 23(A).

In this case, the print processor 55a performs color printing for the aggregate page in which the page 31a and the page 31b are aggregated and the aggregate page in which the page 31g and the page 31h are aggregated, and performs monochrome printing for the aggregate page in which the page 31c and the page 31d are aggregated and the aggregate page in which the page 31e and the page 31f are aggregated.

On the other hand, when the prohibition instruction reception area 41b as shown in FIG. 13 is touched by the user and thereafter the arrangement sequence of pages is modified by insertion of the page (page 33 in the example of FIG. 23) included in different manuscript, the modification aggregation determination portion 57e determines whether or not a color image page and a monochrome image page are to be intermixed in the same aggregate page aggregated in arrangement sequence of pages after the modification.

When a color image page and a monochrome image page are to be intermixed in the same aggregate page, the display controller 57f then controls the display 52 to cause the display 52 to display a warning message to the effect that the aggregate page in which a color image page and a monochrome image page are intermixed is subjected to monochrome printing, similarly to the case explained in FIG. 15.

In the example of FIG. 23(B), as a result of modifying arrangement sequence of pages by insertion of the page 33, the monochrome image page 31f and the color image page 31g are to be intermixed in the same aggregate page 32d, so that the display controller 57f causes the display 52 to display a warning message similar to the warning message 41 shown in FIG. 15.

When the permission instruction reception area 41a as shown in FIG. 15 is touched by the user and thereafter a printing instruction of aggregate pages is received from the user, the print processor 55a performs printing of the aggregate pages 32a to 32d in which the page 31a and the page 31b, the page 31c and the page 33, the page 31d and the page 31e, and the page 31f and the page 31g are aggregated, respectively as shown in FIG. 23(B). Additionally, the print processor 55a performs printing of the aggregate page 32e which includes only the page 31h. In this case, the print processor 55a performs color printing for the aggregate pages 32a, 32b and 32e, and performs monochrome printing for the aggregate pages 32c and 32d.

On the other hand, when the prohibition instruction reception area 41b as shown in FIG. 15 is touched by the user, the print processor 55a cancels execution of the insertion processing of the page 33. When a printing instruction is received from the user, the print processor 55a then executes printing of the aggregate page in which pages are aggregated in the arrangement sequence when the page 33 is not inserted as shown in FIG. 23(A).

Note that, execution of insertion processing of the page 33 may be executed without cancelling execution of the insertion processing so as to perform color printing for the aggregate page 32d including the page 31 of the color image that is subjected to monochrome printing. In this case, since printing of the page 31f which is the monochrome image becomes color printing, the image formation device may display a warning message to the effect that the page 31f is subjected to color printing.

Moreover, when the comparison instruction reception area 41c as shown in FIG. 15 is touched by the user, similarly to the cases explained in FIG. 16, the display controller 57f controls the display 52 to cause the display 52 to display the preview screen 40 of both the aggregate pages in page number sequence before insertion of the page 33 and the aggregate pages in page number sequence after insertion of the page 33.

Then, similarly to the cases explained in FIG. 16, by detecting that the page number sequence enter button 47 is touched by the user, the instruction reception portion 57b receives selection of whether to print each aggregate page in page number sequence before page insertion or print each aggregate page in page number sequence after page insertion. The print processor 55a then performs printing of the aggregate pages in the selected page number sequence.

As described above, when the instruction reception portion 57b receives the modification instruction for instructing to insert an icon corresponding to a page included in different manuscript from manuscript to be printed ahead of a page included in the above-described manuscript to modify arrangement sequence of each page, the modification aggregation determination portion 57e, on the basis of information of an attribute of the page included in the above-described manuscript and information of an attribute of the page included in the above-described different manuscript, determines whether or not the modification to the arrangement sequence results in intermixing of pages with a different attribute in the same aggregate page, so that even when a page included in different manuscript from manuscript to be printed is inserted to modify arrangement sequence of each page, it is possible to notify the user that the monochrome aggregate page is printed and to effectively assist page edit working by the user.

Moreover, since the display 52 displays the preview screen in which icons corresponding to each page of the above-described manuscript in page number sequence are arranged as well as icons corresponding to each page of the above-described different manuscript are arranged in page number sequence, it is possible to simplify page edit working by the user.

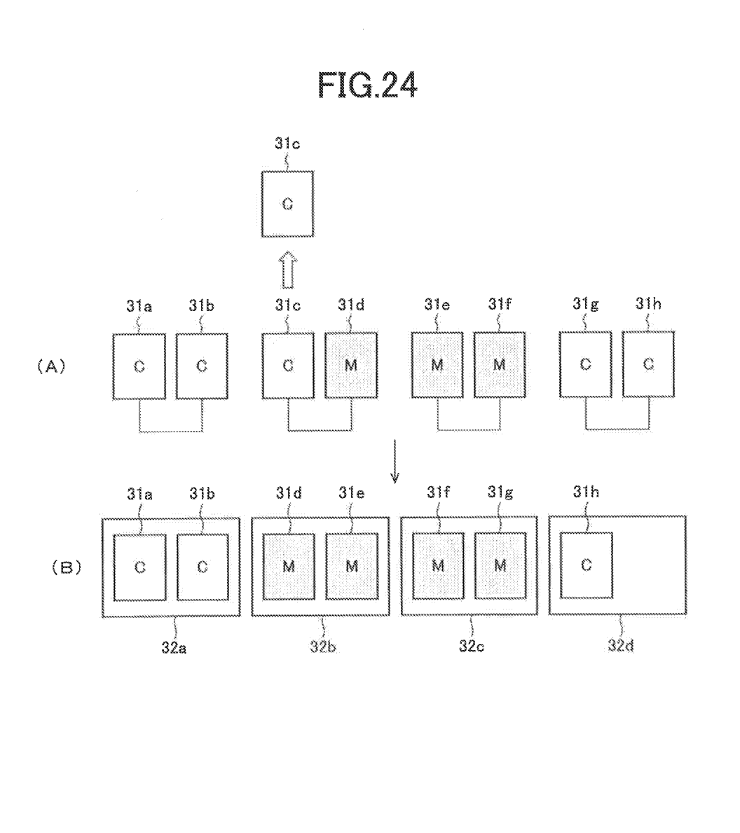

In addition, the modification to arrangement sequence of pages may be by deleting a page. FIG. 24 is a view explaining an example of page aggregate processing when a page is deleted. In FIG. 24(A), shown is a case where the page 31c is deleted.

In this page aggregate processing, the aggregation determination portion 57d firstly determines, when each page included in a manuscript is aggregated being arranged in its page number sequence, whether or not a color image page and a monochrome image page are to be intermixed in the same aggregate page. When a color image page and a monochrome image page are to be intermixed in the same aggregate page, the display controller 57f then controls the display 52 to cause the display 52 to display a warning message to the effect that an aggregate page in which a color image page and a monochrome image page are intermixed is subjected to monochrome printing, similarly to the case explained in FIG. 13.

In the example of FIG. 24(A), when each of the pages 31a to 31h included in a manuscript is arranged in its page number sequence, the page 31c and the page 31d are to be intermixed in the same aggregate page, so that the display controller 57f causes the display 52 to display a warning message similar to the warning message 41 shown in FIG. 13.

When the permission instruction reception area 41a as shown in FIG. 13 is touched by the user and thereafter a printing instruction of aggregate pages is received from the user, the print processor 55a then performs printing of the aggregate pages in which the page 31a and the page 31b, the page 31c and the page 31d, the page 31e and the page 31f, and the page 31g and the page 31h are aggregated, respectively as shown in FIG. 24(A).

In this case, the print processor 55a performs color printing for the aggregate page in which the page 31a and the page 31b are aggregated and the aggregate page in which the page 31g and the page 31h are aggregated, and performs monochrome printing for the aggregate page in which the page 31c and the page 31d are aggregated and the aggregate page in which the page 31e and the page 31f are aggregated.

On the other hand, when the prohibition instruction reception area 41b as shown in FIG. 13 is touched by the user and there after the arrangement sequence of pages is modified by deletion of a page, the modification aggregation determination portion 57e determines whether or not a color image page and a monochrome image page are to be intermixed in the same aggregate page aggregated in arrangement sequence of pages after the modification.

When a color image page and a monochrome image page are to be intermixed in the same aggregate page, the display controller 57f then controls the display 52 to cause the display 52 to display a warning message to the effect that the aggregate page in which a color image page and a monochrome image page are intermixed is subjected to monochrome printing, similarly to the case explained in FIG. 15.

In the example of FIG. 24(B), as a result of modifying arrangement sequence of pages by deletion of the page 31c, the monochrome image page 31f and the color image page 31g are to be intermixed in the same aggregate page 32c, so that the display controller 57f causes the display 52 to display a warning message similar to the warning message 41 shown in FIG. 15.

When the permission instruction reception area 41a as shown in FIG. 15 is touched by the user and thereafter a printing instruction of aggregate pages is received from the user, the print processor 55a performs printing of the aggregate pages 32a to 32c in which the page 31a and the page 31b, the page 31d and the page 31e, and the page 31f and the page 31g are aggregated, respectively as shown in FIG. 24(B). Additionally, the print processor 55a performs printing of the aggregate page 32d which includes only the page 31h. In this case, the print processor 55a performs color printing for the aggregate pages 32a and 32d, and performs monochrome printing for the aggregate pages 32b and 32c.

On the other hand, when the prohibition instruction reception area 41b as shown in FIG. 15 is touched by the user, the print processor 55a cancels execution of the deletion processing of the page 31c. When the printing instruction is received from the user, the print processor 55a then executes printing of the aggregate page in which pages are aggregated in the arrangement sequence when the page 31c is not deleted.

Note that, deletion processing of the page 31c may be executed without cancelling execution of the deletion processing so as to perform color printing for the aggregate page 32c including the page 31g of the color image that is subjected to monochrome printing. In this case, since printing of the page 31f which is the monochrome image becomes color printing, the image formation device may display a warning message to the effect that the page 31f is subjected to color printing.

Moreover, when the comparison instruction reception area 41c as shown in FIG. 15 is touched by the user, similarly to the cases explained in FIG. 16, the display controller 57f controls the display 52 to cause the display 52 to display the preview screen 40 of both the aggregate pages in page number sequence before deletion of the page 31c and the aggregate pages in page number sequence after deletion of the page 31c.

Then, similarly to the cases explained in FIG. 16, by detecting that the page number sequence enter button 47 is touched by the user, the instruction reception portion 57b receives selection of whether to print each aggregate page in page number sequence before page deletion or print each aggregate page in page number sequence after page deletion. The print processor 55a then performs printing of the aggregate pages in the selected page number sequence.

As described above, since the instruction reception portion 57b receives the modification instruction for instructing to delete a page include in a manuscript to modify arrangement sequence of each page from the user, even when the user performs deletion of a page included in an aggregate page, it is possible to notify the user that print processing becomes monochrome printing, and to effectively assist page edit working by the user.

Moreover, in the above-described embodiment, though a warning message is displayed when a color image page and a monochrome image page are intermixed in an aggregate page, the present invention could be also applied in the same manner to a case where a page attribute other than the attribute including a color image or a monochrome image is used.

For example, in such a case where pages with a different image format are intermixed in an aggregate page and the format of each page is converted into any of the formats, the image formation device may display a warning message.

Moreover, in such a case where an output color is set so as to perform color printing or monochrome printing for each page, pages with a different output color are intermixed in an aggregate page and the output color of each page is converted into any of the output colors, the image formation device may display a warning message.

In addition, in such a case where pages with different gradation are intermixed in an aggregate page and the gradation of each page is converted into any of the gradations, a warning message may be displayed. For example, in such a case where a page of an image with 2-level gradation and a page of an image with 8-level gradation are intermixed in an aggregate page and the gradation of each page is converted into the 2-level gradation, the image formation device may display a warning message.

### Embodiment 3

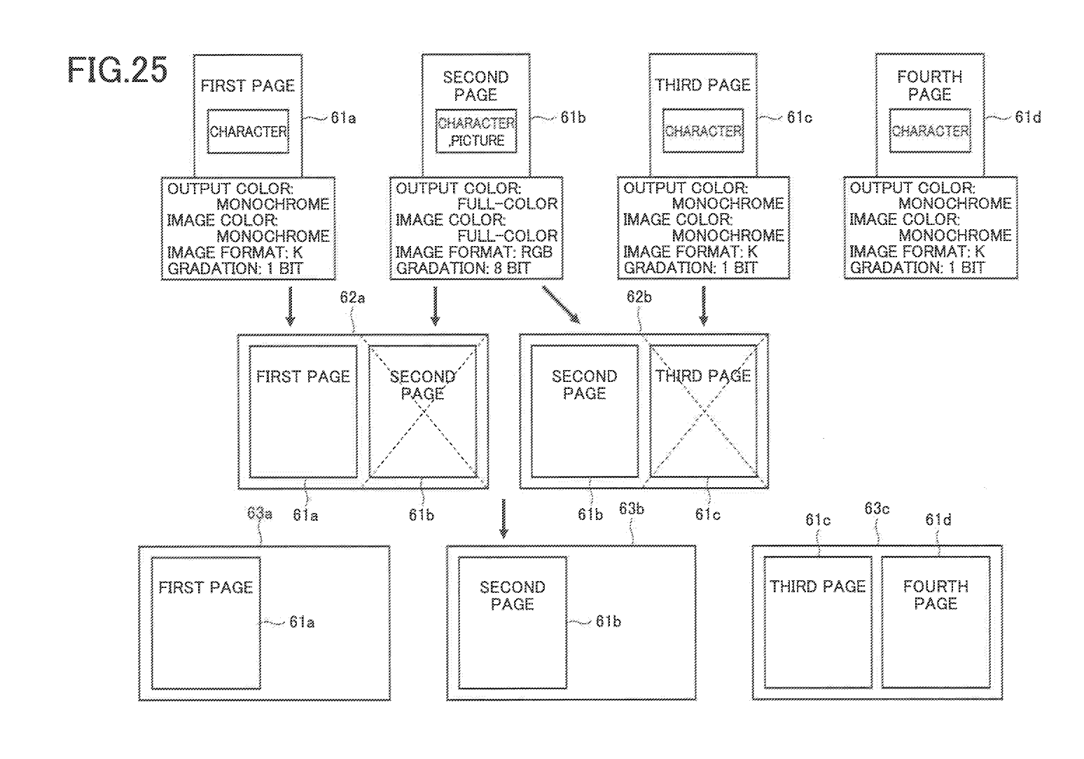

Description will hereinafter be given specifically for an embodiment 3 of the present invention with reference to drawings. First, description will be given for image formation processing according to the embodiment 3 of the present invention. FIG. 25 is a view explaining an example of page aggregate processing according to the embodiment 3 of the present invention.

Here, description will be given taking image formation processing for printing an aggregate page in which two pages are aggregated into one page as an example. In page aggregate processing according to the embodiment 3 of the present invention, when a page attribute changes between previous and following pages, as will be described below, page break is performed in aggregate pages and the aggregate page including the following page is printed separately from the aggregate page including the previous page. Note that, in the following example, information of gradation is used as a page attribute, but without limitation thereto, other page attributes such as an image color and an image format described below may be used.

In FIG. 25, respective pages 61a to 61d of a manuscript image read in sequence by a scan function of the image formation device are shown. The first page 61a, the third page 61c and the fourth page 61d of the manuscript image are pages including only characters, and the second page 61b is a page including characters and a picture.

Moreover, each of the pages 61a to 61d has attribute information. The attribute information includes information of an output color, an image color, an image format and gradation. The output color is setting information of whether the image formation device, when printing an image, performs full-color printing or monochrome printing. This output color is set by the image formation device depending on whether the image color described below is “monochrome” or “full-color”.

The image color is information showing whether the image data is a full-color image or a monochrome image. This image color is determined by the image formation device at the time of scanning manuscript.

The image format is information showing whether the image data has an RGB format or a K (monochrome) format. This image format is determined by the image formation device at the time of scanning manuscript. The RGB format is a format indicating a color of each pixel of the image with gradation of three primary colors of red (Red), green (Green) and blue (Blue). The K format is a format indicating a color of each pixel of the image with gradation of black.

The gradation is information indicating the number of stages of shade of a color. This gradation is determined by the image formation device at the time of scanning manuscript. For example, when the image format is the K format and the gradation is 1 bit, color expression is performed in two stages of white and black. Moreover, when the image format is the RGB format and the gradation is 8 bits, color expression is performed in 256 levels for each color of red, green and blue.

In the example of FIG. 25, as to the first page 61a, the third page 61c and the fourth page 61d, the output color is “monochrome”, the image color is “monochrome”, the image format is “K format” and the gradation is “1 bit”. In addition, as to the second page 61b, the output color is “full-color”, the image color is “full-color”, the image format is “RGB format” and the gradation is “8 bits”.

When the user instructs the image formation device to print an aggregate page in which two page are aggregated into one page, the image formation device is to print an aggregate page 62a in which the first page 61a and the second page 61b are aggregated, but the gradation of the first page 61a “1 bit” and the gradation of the second page 61b “8 bits” are different, so that the image formation device does not perform processing for printing the aggregate page 62a but performs processing for printing the aggregate page 63a including only the first page 61a in monochrome.

Next, since the second page 61b is not aggregated to the aggregate page 63a including the first page 61a, the image formation device is to print the aggregate page 62b in which the second page 61b and the third page 61c are aggregated, but the gradation of the second page 61b “8 bits” and the gradation of the third page 61c “1 bit” are different, so that the image formation device does not perform processing for printing the aggregate page 62b but performs processing for printing the aggregate page 63b including only the second page 61b in color.

Further, since the third page 61c is not aggregated to the aggregate page 63b including the second page 61b and the gradation of the third page 61c “1 bit” and the gradation of the fourth page 61d “1 bit” are the same, the image formation device performs processing for printing the aggregate page 63c in which the third page 61c and the fourth page 61d are aggregated in monochrome.

As described above, when the gradation changes between previous and following pages, the image formation device performs page break in aggregate pages and prints the aggregate page including the previous page and the aggregate page including the following page separately, so that it never happens unbeknown to the user that the page number sequence is modified and the following page is printed before the previous page.

Moreover, the image formation device prints pages with different gradations by aggregating to separate aggregate pages, and is therefore able to perform printing with the gradation of the page kept, so that the gradation of the image is never modified unbeknown to the user.

In this manner, according to the above-described processing, it becomes possible to print aggregate pages in the page number sequence and with the gradation desired by the user. In addition, by using the gradation as the page attribute, it becomes possible to perform printing of aggregate pages so that pages with different gradation from each other are included in different aggregate pages. This makes it possible to cause the gradation not to be converted into lower gradation unexpectedly, so that it is possible to prevent occurrence of a situation where a printed image has an appearance degraded and lacks clarity.

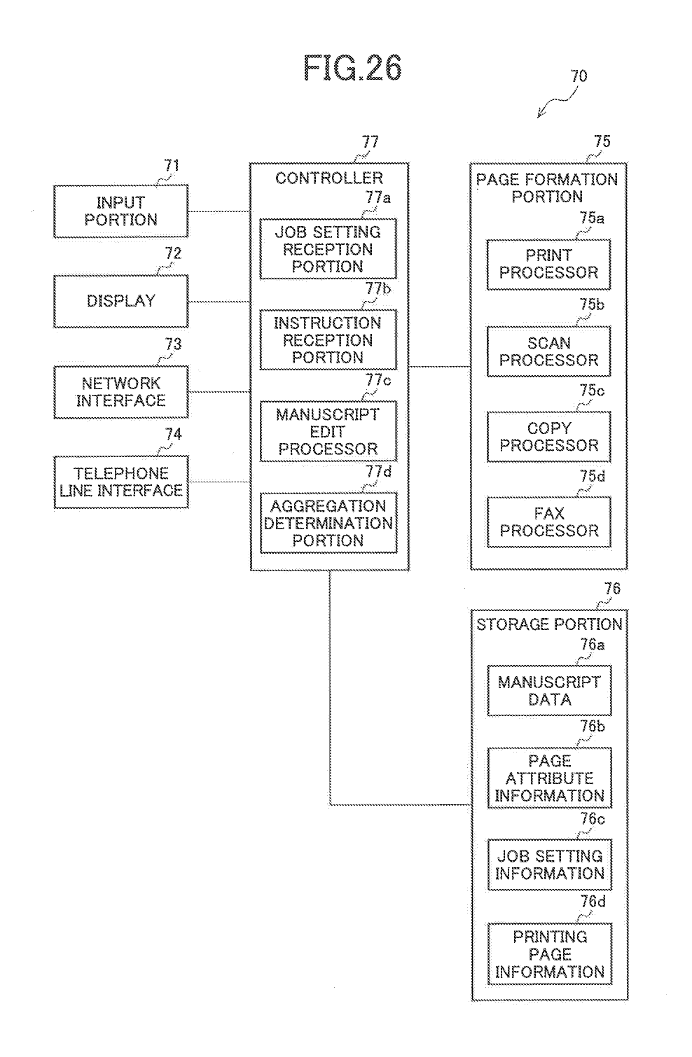

Next, description will be given for a functional structure of an image formation device according to the embodiment 3 of the present invention. Here, the image formation device includes a device which forms an image, such as an MFP (Multifunction Peripheral), a printer, a copier or a facsimile. Description will be given below for a case where the image formation device is an MFP. FIG. 26 is a block diagram showing an example of a functional structure of an image formation device 70 according to the embodiment of the present invention.

As shown in FIG. 26, the image formation device 70 is provided with an input portion 71, a display 72, a network interface 73, a telephone line interface 74, a page formation portion 75, a storage portion 76 and a controller 77.

The input portion 71 is an input device consisting of a touch pad and the like. The display 72 is a display device consisting of a liquid crystal panel and the like. The input portion 71 and the display 72 constitute the touch panel in combination with each other.

The network interface 73 is a processor which performs communication with other communication device through a network such as a LAN (Local Area Network). The telephone line interface 74 is a processor which performs communication with other device such as a Fax device through a telephone line.

The page formation portion 75 is a processor which executes various image formation processing. This page formation portion 75 is provided with a print processor 75a, a scan processor 75b, a copy processor 75c, and a Fax processor 75d.

The print processor 75a is a processor which performs print processing of manuscript data. For example, at the time of aggregate printing, when pages aggregated into one page are all color images, the print processor 75a generates image data of an aggregate page of the color image and performs color printing of the generated image data. In addition, when pages aggregated into one page are all monochrome images, the print processor 75a generates image data of an aggregate page of the monochrome image and performs monochrome printing of the generated image data.

Further, at the time of printing aggregate pages by aggregating each page in page number sequence, when it is determined that gradation changes between previous and following pages, as explained with the use of FIG. 25, the print processor 75a performs page break in the aggregate pages and prints the aggregate page including the following page separately from the aggregate page including the previous page.

The scan processor 75b is a processor which performs scan processing of manuscript. This scan processor 75b performs processing for determining an output color, an image color, an image format or gradation with respect to image data of each page read by scan processing, or processing for allocating a page number to the read image data.

The copy processor 75c is a processor which performs copy processing of manuscript data. When performing copy processing, the copy processor 75c requests the scan processor 75b to scan manuscript, and requests the print processor 75a to print the resulting image data. The Fax processor 75d is a processor which performs Fax transmission/reception processing.

The storage portion 76 is a storage device such as a memory or a hard disc device. This storage portion 76 stores data such as manuscript data 76a, page attribute information 76b, job setting information 76c, and printing page information 76d.

The manuscript data 76a is image data of manuscript read by the scan processor 75b and image data of Fax received by the Fax processor 75d.

The page attribute information 76b is attribute information of each page in which image data is stored as the manuscript data 76a. For example, the page attribute information 76b includes information of an output color, an image color, an image format, gradation and the like of each page stored as the manuscript data 76a.

The job setting information 76c is setting information of a job inputted by operating the input portion 71 by the user. For example, the job setting information 76c includes information of whether or not to perform page aggregation, information of the number of pages to be included in one page when page aggregation is performed, and the like.

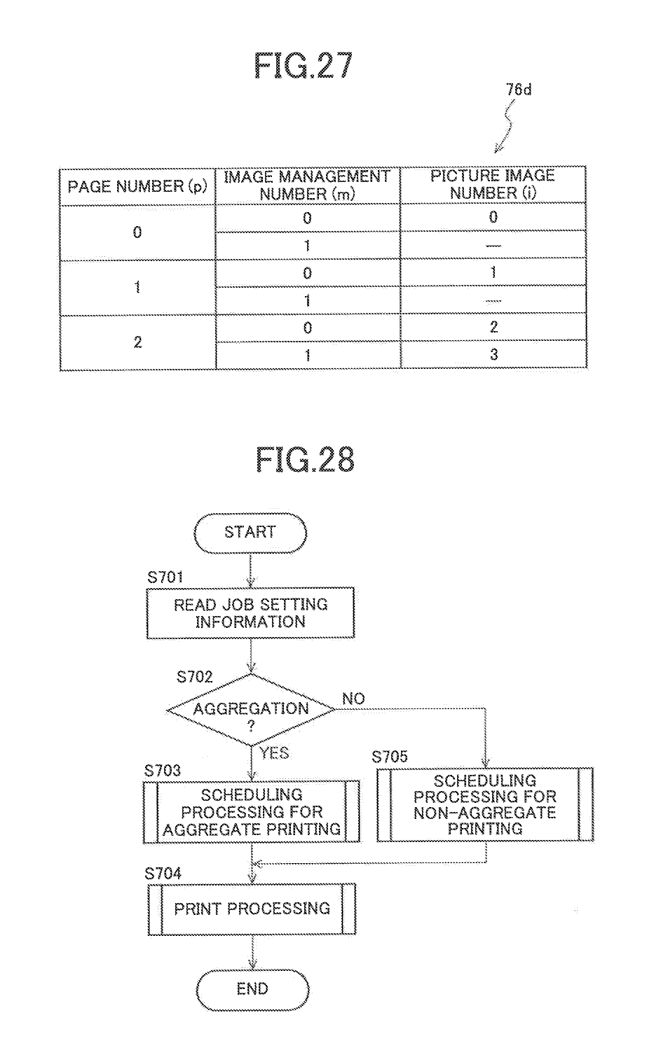

The printing page information 76d is information showing a correspondence relation between a page of a sheet for printing and a page of manuscript data to be printed on each sheet. FIG. 27 is a view showing an example of the printing page information 76d. The printing page information 76d shown in FIG. 27 corresponds to the example shown in FIG. 25.

The printing page information 76d includes information of a sheet page number (p), an image management number (m) and a picture image number (i). The sheet page number is a page number of a sheet on which a picture image is printed. In the example of FIG. 25, since three aggregate pages 63a to 63c are printed, sheet page numbers form 0 to 2 are registered in the printing page information 76d of FIG. 27.

The image management number is a serial number allocated to each page aggregated into one page. In the example of FIG. 25, since picture images for two pages are aggregated into one page, the image management numbers of 0 and 1 are registered in the printing page information 76d of FIG. 27. Moreover, for example, when picture images for four pages are aggregated into one page, the image management numbers of 0 to 3 are registered.

The picture image number is a serial number allocated to each page including a picture image to be printed in sequence from the top page. In the example of FIG. 25, since there are four pages 61a to 61d of the picture images to be printed, picture image numbers 0 to 3 are registered in the printing page information 76d of FIG. 27.

Moreover, in the example of FIG. 27, the image management numbers “0” and “1” are registered corresponding to the sheet page number “0”. This shows that aggregate printing in which two pages are aggregated into one page is performed. In addition, the picture image number “0” is registered corresponding to the sheet page number “0” and the image management number “0”. This shows that aggregate printing of the page including the picture image of the picture image number “0” is performed. Further, the picture image number corresponding to the sheet page number “0” and the image management number “1” is not registered. This shows that there is no page corresponding to the image management number “1” that is aggregated to the sheet of “0”th page. With such information, the aggregate page 63a shown in FIG. 25 is printed. It is the same for the sheet page number “1”.

Moreover, in the example of FIG. 27, the picture image number “2” is registered corresponding to the sheet page number “2” and the image management number “0”, and the picture image number “3” is registered corresponding to the sheet page number “2” and the image management number “1”. This shows that aggregate printing of pages including the picture images of the picture image numbers “2” and “3” is performed on the sheet of the “2”nd page. With such information, the aggregate page 63c shown in FIG. 25 is printed.

The controller 77 is a controlling device such as a CPU (Central Processing Unit) which controls the image formation device 70 totally. This controller 77 is provided with a job setting reception portion 77a, an instruction reception portion 77b, a manuscript edit processor 77c, and an aggregation determination portion 77d.

The job setting reception portion 77a is a processor which receives setting information of a job from the user through the input portion 71. The job setting reception portion 77a stores the received setting information in the storage portion 76 as the job setting information 76c.

The instruction reception portion 77b is a processor which receives an instruction to edit manuscript to be printed from the user through the input portion 71. For example, the instruction reception portion 77b receives an instruction to modify arrangement sequence of pages by page insertion or the like from the user. The manuscript edit processor 77c is a processor which performs processing for editing manuscript to be printed in accordance with the edit instruction received by the instruction reception portion 77b.

The aggregation determination portion 77d is a processor which, when aggregate pages are formed by aggregating each page in page number sequence, determines whether or not the gradation of the page changes between previous and following pages. When it is determined by the aggregation determination portion 77d that the gradation of the page changes between previous and following pages, the print processor 75a performs page break in the aggregate pages and prints the aggregate page which includes the following page separately from the aggregate page which includes the previous page.

Next, description will be given for processing procedure of image formation processing according to the embodiment 3 of the present invention. FIG. 28 is a flowchart showing an example of processing procedure of image formation processing according to the embodiment 3 of the present invention.

First, the aggregation determination portion 77d of the image formation device 70 reads the job setting information 76c from the storage portion 76 (step S701). The aggregation determination portion 77d then determines whether or not information showing that page aggregation is performed is set to the job setting information 76c (step S702). This information is set by the user.

When information showing that page aggregation is performed is not set to the job setting information 76c (in the case of NO step at S702), the print processor 75a executes scheduling processing for a case where printing is performed without performing page aggregation (scheduling processing for non-aggregate printing) (step S705). Here, the scheduling processing is processing for generating image data for which printing is performed. This scheduling processing will be described below specifically.

When information showing that page aggregation is performed is set in the job setting information 76c at step S702 (in the case of YES at step S702), the print processor 75a executes scheduling processing for a case where printing is performed after performing page aggregation (scheduling processing for aggregate printing) (step S703). This scheduling processing will be described below specifically.

After the processing of step S703 or step S705, the print processor 75a executes print processing for printing the generated image data (step S704), and this image formation processing ends. This print processing will be described below specifically.

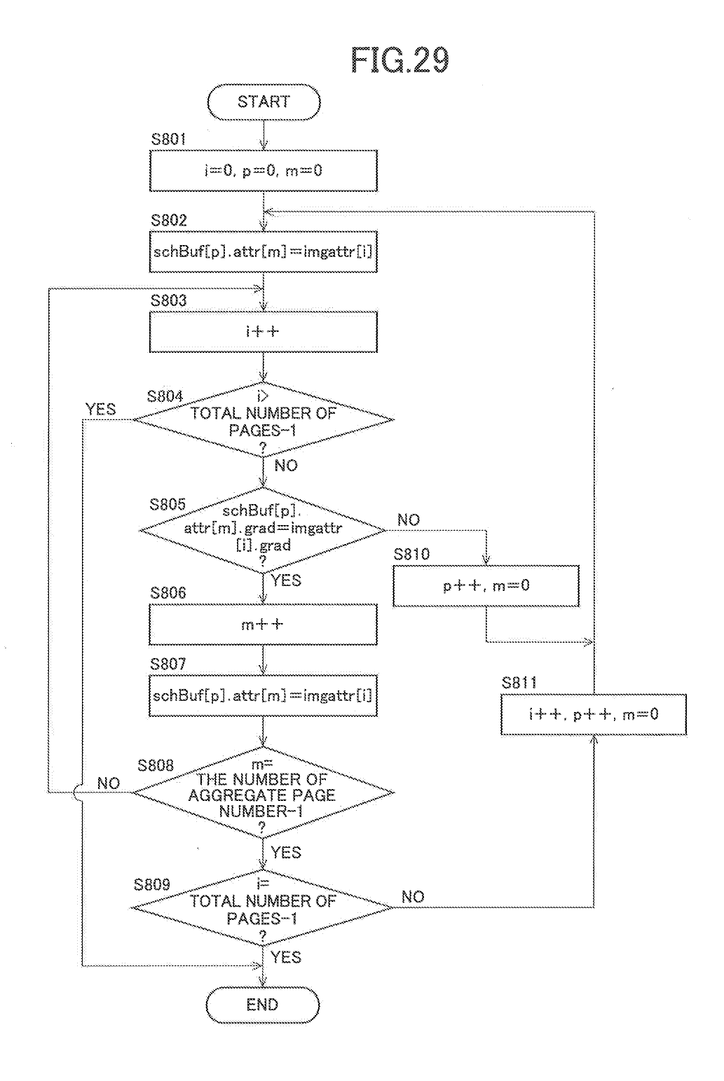

Next, description will be given for processing procedure of scheduling processing for aggregate printing shown in step S703 of FIG. 28. FIG. 29 is a flowchart showing an example of processing procedure of scheduling processing for aggregate printing.

First, the print processor 75a of the image formation device 70 sets the picture image number i, the sheet page number p and the image management number m to 0 (step S801). The print processor 75a then sets an attribute (schBuf[p].attr[m]) of a page with the image management number m that is aggregated to a sheet with the sheet page number p to the same attribute as an attribute (imagattr[i]) of a page with the picture image number i (step S802). Here, the attribute of a page refers to an output color, an image color, an image format, gradation or the like explained in FIG. 25.

At this time, the print processor 75a stores parameters (sheet page number p, image management number m, picture image number i) at the time of setting the attribute as the printing page information 76d in the storage portion 76. For example, the print processor 75a registers “0”, “0” and “0” for the sheet page number p, the image management number m and the picture image number i, respectively as shown in FIG. 27.

Thereafter, the print processor 75a increments the picture image number i by one (step S803). The print processor 75a then determines whether or not the picture image number i is larger than a value where one is decremented from the total number of pages of manuscript to be printed (step S804). The picture image number i being larger than the value where one is decremented from the total number of pages of manuscript to be printed means that scheduling processing for all pages included in the manuscript is completed.

When the picture image number i is larger than the value where one is decremented from the total number of pages of manuscript to be printed (in the case of YES at step S804), scheduling processing for all pages included in the manuscript is completed, so that this scheduling processing for aggregate printing ends.

When the picture image number i is not larger than the value where one is decremented from the total number of pages of manuscript to be printed (in the case of NO at step S804), the print processor 75a determines whether or not gradation (schBuf[p].attr[m].grad) of a page to which the attribute (schBuf[p].attr[m]) is set earlier at step S802 matches gradation (imagattr[i].grad) set to the attribute (imagattr[i]) of a page next to the page (step S805).

When these gradations do not match (in the case of NO at step S805), the print processor 75a increments the sheet page number p by one (corresponding to page break) and further sets the image management number m to 0 (step S810). Thereafter, the procedure moves to step S802 and subsequent processing is executed. Thereby, the page which has different gradation from gradation of the page to which the attribute is set earlier is included in an aggregate page different from an aggregate page in which the page to which the attribute is set earlier is included.

When the gradation of the page to which the attribute is set earlier matches the gradation set to the attribute of a page next to the page at step S805 (in the case of YES at step S805), the print processor 75a increments the image management number m by one (step S806).

The print processor 75a then sets the attribute (schBuf[p].attr[m]) of the page with the image management number m that is aggregated to the sheet with the sheet page number p to the same attribute as the attribute (imagattr[i]) of the page with the picture image number i (step S807).

At this time, the print processor 75a stores parameters (sheet page number p, image management number m, picture image number i) at the time of setting the attribute as the printing page information 76d in the storage portion 76.

Thereafter, the print processor 75a determines whether or not the image management number m is equal to a value where one is decremented from the aggregate page number (The number of pages to be aggregated into one page. 2 in the case of 2 in 1 printing, 4 in the case of 4 in 1 printing.) (step S808). The image management number m being equal to the value where one is decremented from the number of pages included in an aggregate page means that the processing for setting the attribute for the number of pages included in the aggregate page is completed.

When the image management number m is not equal to the value where one is decremented from the number of pages included in the aggregate page number (in the case of NO at step S808), the procedure moves to step S803, and subsequent processing is continued.

When the image management number m is equal to the value where one is decremented from the number of pages included in the aggregate page number (in the case of YES at step S808), the print processor 75a determines whether or not the picture image number i is equal to the value where one is decremented from the total number of pages of manuscript to be printed (step S809). The picture image number i being equal to the value where one is decremented from the total number of pages of manuscript to be printed means that scheduling processing for all pages included in the manuscript is completed.

When the picture image number i is not equal to the value where one is decremented from the total number of pages of manuscript to be printed (in the case of NO at step S809), the print processor 75a increments the picture image number i by one and increments the sheet page number p by one, and further sets the image management number m to 0 (step S811). Thereafter, the procedure moves to step S802, and subsequent processing is continued. Thereby, an aggregate page targeted for the scheduling processing shifts to a next aggregate page.

When the picture image number i is equal to the value where one is decremented from the total number of pages of manuscript to be printed at step S809 (in the case of YES at step S809), the scheduling processing for all pages included in the manuscript ends, so that this scheduling processing for aggregate printing ends.

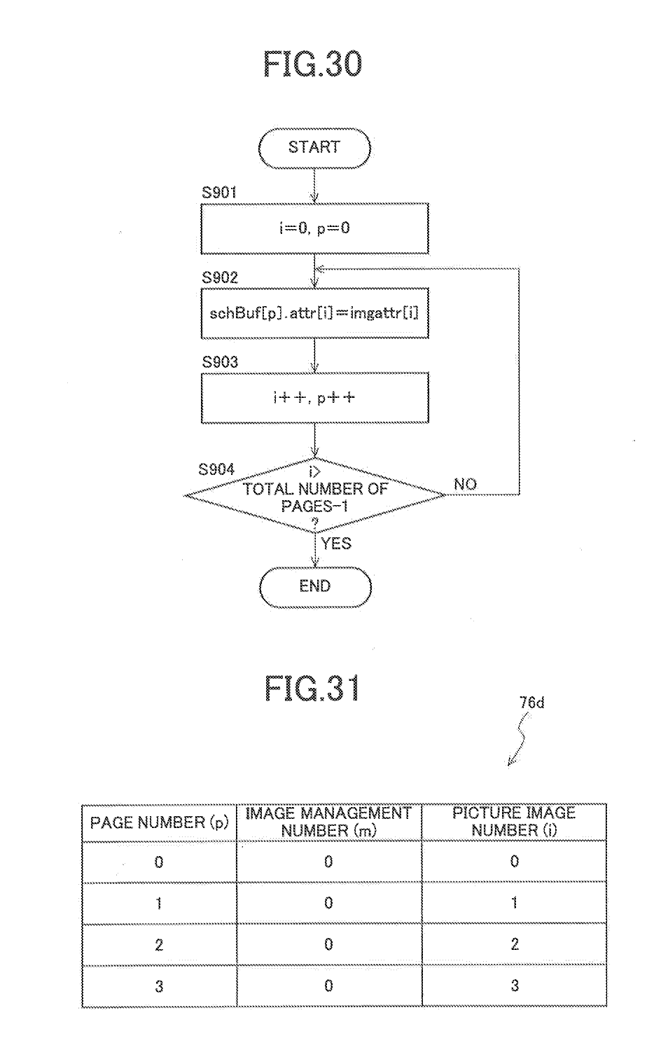

Next, description will be given for processing procedure of the scheduling processing for non-aggregate printing shown in step S705 of FIG. 28. FIG. 30 is a flowchart showing an example of processing procedure of scheduling processing for non-aggregate printing.

First, the print processor 75a of the image formation device 70 sets the picture image number i and the sheet page number p to 0 (step S901). The print processor 75a then sets an attribute (schBuf[p].attr[i]) of a page with the image management number m that is aggregated to a sheet with the sheet page number p to the same attribute as an attribute (imagattr[i]) of a page with the picture image number i (step S902).

At this time, the print processor 75a stores parameters (sheet page number p, image management number m, picture image number i) at the time of setting the attribute as the printing page information 76d in the storage portion 76. Note that, when aggregate printing is not performed, the image management number m is set to “0”. FIG. 31 is a view showing an example of the printing page information 76d when aggregate printing is not performed. Since aggregate printing is not performed differently from the case of FIG. 27, each one of the image management number and the picture image number is related to the sheet page number.

After the processing of step S902, the print processor 75a increments the picture image number i by one and further increments the sheet page number p by one (corresponding to page break) (step S903). The print processor 75a then determines whether or not the picture image number i is larger than the value where one is decremented from the total number of pages of manuscript to be printed (step S904). The picture image number i being larger than the value where one is decremented from the total number of pages of manuscript to be printed means that scheduling processing for all pages included in the manuscript is completed.

When the picture image number i is larger than the value where one is decremented from the total number of pages of manuscript to be printed (in the case of YES at step S904), scheduling processing for all pages included in the manuscript ends, so that this scheduling processing for non-aggregate printing ends.

When the picture image number i is not larger than the value where one is decremented from the total number of pages of manuscript to be printed (in the case of NO at step S904), the procedure moves to step S902, and subsequent processing is continued.

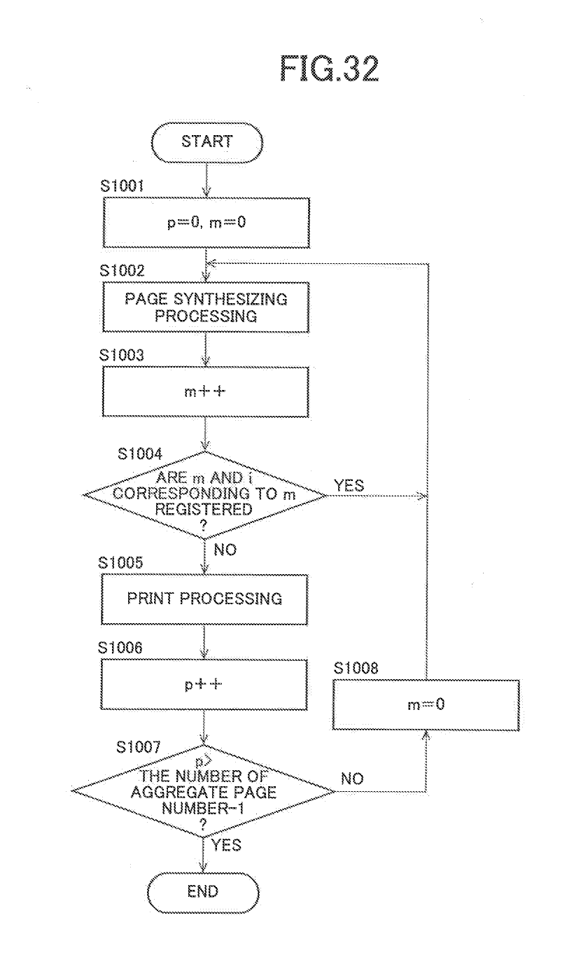

Next, description will be given for processing procedure of the print processing shown in step S704 of FIG. 28. FIG. 32 is a flowchart showing an example of processing procedure of print processing.

First, the print processor 75a of the image formation device 70 sets the sheet page number p and the image management number m to 0 (step S1001). The print processor 75a then executes page synthesizing processing (step S1002). Specifically, the print processor 75a refers to the printing page information 76d as shown in an example in FIG. 27 and FIG. 31, and synthesizes a picture image of the page with the picture image number i corresponding to the image management number m with the aggregate page which has the same sheet page number p.

For example, in FIG. 27, when the sheet page number p, the image management number m and the picture image number i are “0”, “0” and “0”, respectively, a picture image of the first page 61a is synthesized with the aggregate page 63a as shown in FIG. 25.

Thereafter, the print processor 75a increments the image management number m by one (step S1003). The print processor 75a then determines whether or not the image management number m and the picture image number i corresponding to image management number m are registered in the printing page information 76d (step S1004).

For example, in FIG. 27, when the sheet page number p and the image management number m are “0” and “1”, respectively, the picture image number i is not registered, so that the result of the above-described determination becomes “NO”. Moreover, when the sheet page number p and the image management number mare “2” and “1”, respectively, “3” is registered as the picture image number i, so that the result of the above-described determination becomes “YES”. Further, when the image management number m becomes “2” by the processing of step S1003, “2” is not registered as the image management number m of the printing page information 76d, so that the result of the above-described determination becomes “NO”.

Note that, when aggregate printing is not performed, only “0” is registered as the image management number m of the printing page information 76d, as shown in an example in FIG. 31, so that when the image management number m is incremented by one by the processing of step S1003, the result of the determination at step S1004 necessarily becomes “NO”.

When the image management number m and the picture image number i corresponding to the image management number m are registered in the printing page information 76d at step S1004 (in the case of YES at step S1004), the procedure moves to step S1002, and the print processor 75a performs processing for synthesizing a picture image of the page with the picture image number i corresponding to the image management number m with the aggregate page which has the same sheet page number p. With such processing, image data of an aggregate page in which a plurality of pages are aggregated into one page is generated. Then, processing subsequent to step S1003 is continuously executed.

When the image management number m and the picture image number i corresponding to the image management number m are not registered in the printing page information 76d at step S1004 (in the case of NO at step S1004), the print processor 75a performs processing for printing the image data obtained as a result of the page synthesizing processing at step S1002 (step S1005).

At this time, the print processor 75a refers to information of the attribute (schBuf[p].attr[m]) set to the page included in the image data at step S802 or step S807 of FIG. 29 or step S902 of FIG. 30. The print processor 75a then performs printing of the image data in a color depending on an output color included in the attribute (full-color or monochrome).

Thereafter, the print processor 75a increments the sheet page number p by one (corresponding to page break) (step S1006). The print processor 75a then determines whether or not the sheet page number p is larger than the value where one is decremented from the total number of aggregate pages (step S1007). The total number of aggregate pages is the total number of aggregate pages to be printed and is “3” in the example of FIG. 27 and “4” in the example of FIG. 31. The sheet page number p being larger than the value where one is decremented from the total number of aggregate pages means that printing of all pages to be printed is completed.

When the sheet page number p is not larger than the value where one is decremented from the total number of aggregate pages (in the case of NO at step S1007), the print processor 75a sets the image management number m to 0 (step S1008). Thereafter, the procedure moves to step S1002, and subsequent processing is continued for a new aggregate page (a new aggregate page whose sheet page number p becomes 1 when the sheet page number p is 1 at step S1006).

When the sheet page number p is larger than the value where one is decremented from the total number of aggregate pages (in the case of YES at step S1007), printing of all pages to be printed is completed, so that this print processing ends.

Note that, in the above-described embodiment 3, the image formation processing has been described by taking processing for printing an aggregate page as an example, but without limitation thereto, may be processing for forming image data of an aggregate page to store in the storage portion 76.

Moreover, in the above-described embodiment 3, description has been given for the image formation processing for a case where arrangement sequence of pages is determined in advance, but the image formation processing may be performed so that when the instruction reception portion 77b receives an instruction to insert a page from the user and arrangement sequence of pages is modified, the aggregation determination portion 77d determines whether or not an attribute of the page changes between previous and following pages, and when it is determined that the attribute of the page changes between previous and following pages, the page formation portion 75 performs page break in aggregate pages to form an aggregate page including the following page separately from an aggregate page including the previous page.

In addition, even when the instruction reception portion 77b receives, from the user, an instruction to insert all or apart of pages included in a file of manuscript different from manuscript which is a current printing target, the processing same as the above-described processing may be executed.

### Other Embodiment

In the meantime, although the embodiments of the image formation device and the image forming method have been mainly described so far, the present invention is not limited to these embodiments and the present invention may be implemented as a form of a computer program for realizing functions of the image formation device or a form of a computer readable recording medium having the computer program recorded therein.

Here, the recording medium may employ various forms of a disk type (for example, such as a magnetic disk and an optical disk), a card type (for example, such as a memory card and an optical card), a semiconductor memory type (for example, such as a ROM and a non-volatile memory), a tape type (for example, such as a magnetic tape and a cassette tape) and the like.

By distributing a recording medium having a computer program which realizes the functions of the image formation device in the above-described embodiments or a computer program which causes a computer to execute the image forming method recorded therein, it is possible to reduce costs and improve portability or versatility.

In addition, the above-described recording medium is mounted to a computer, a computer program recorded in the recording medium is read by the computer to be stored in a memory, and the computer program is read from the memory by a processor (CPU: Central Processing Unit, MPU: Micro Processing Unit) provided in the computer for execution, so that it is possible to realize the functions of the image formation device according to these embodiments and execute the image forming method.

Moreover, the present invention is not limited to the embodiments described above and may variously be modified and altered within a range without departing from the spirit of the present invention.

### REFERENCE SIGNS LIST

1a to 1j, 4, 31a to 31h, 33, 61a to 61d . . . page, 2a to 2f, 32a to 32e, 62a, 62b, 63a to 63c . . . aggregate page, 3, 5, 41 . . . warning message, 3a, 41a . . . permission instruction reception area, 3b, 41b . . . prohibition instruction reception area, 10, 50, 70 . . . image formation device, 11, 51, 71 . . . input portion, 12, 52, 72 . . . display, 13, 53, 73 . . . network interface, 14, 54, 74 . . . telephone line interface, 15, 55, 75 . . . page formation portion, 15a, 55a, 75a . . . print processor, 15b, 55b, 75b . . . scan processor, 15c, 55c, 75c . . . copy processor, 15d, 55d, 75d . . . Fax processor, 16, 56, 76 . . . storage portion, 16a, 56a, 76a . . . manuscript data, 16b, 56b, 76b . . . page attribute information, 16c, 56c, 76c . . . job setting information, 76d . . . printing page information, 17, 57, 77 . . . controller, 17a, 57a, 77a . . . job setting reception portion, 17b, 57b, 77b . . . instruction reception portion, 17c, 57c, 77c . . . manuscript edit processor, 17d, 57e . . . modification aggregation determination portion, 17e, 57f . . . display controller, 20, 40 . . . preview screen, 21, 42 . . . page display area, 22a to 22d, 43a to 43d . . . go button, 23a to 23f, 25a to 25f, 44a to 44h . . . icon, 24 . . . connection line, 26, 46 . . . highlighting frame line, 41c . . . comparison instruction reception area, and 57d, 77d . . . aggregation determination portion.

1-15. (canceled)

16. An image formation device forming an aggregate page in which a plurality of pages included in a manuscript are aggregated into one page, comprising:
a storage portion for storing information of an attribute of each page;
a display for displaying a preview screen in which icons corresponding to each page included in the manuscript are arranged in page number sequence;
an instruction reception portion for receiving, from a user, a modification instruction for instructing to modify arrangement sequence of each page according to modification to arrangement sequence of the icons performed by the user in the preview screen displayed on the display;
a modification aggregation determination portion for determining whether or not the modification to the arrangement sequence results in intermixing of pages the attributes of which are different in a same aggregate page on the basis of the information of the attribute when the instruction reception portion receives the modification instruction; and
a display controller for, when the modification aggregation determination portion determines that pages the attributes of which are different are to be intermixed in the same aggregate page, controlling the display to cause the display to display a warning message.

17. The image formation device as defined in claim 16, wherein
the information of the attribute is information of whether an image of each page is a color image or a monochrome image, a page formation portion for aggregating the plurality of pages in which a color image page and a monochrome image page are intermixed to one page to form a color or monochrome aggregate page is further included, and when it is determined by the modification aggregation determination portion that a color image page and a monochrome image page are to be intermixed in the same aggregate page, the display controller causes the display to display a message for giving notice that a color aggregate page is formed or a monochrome aggregate page is formed by the page formation portion as the warning message.

18. The image formation device as defined in claim 16, wherein
the information of the attribute is information of whether an image of each page is a color image or a monochrome image, a modification prohibition processor for prohibiting the modification to the arrangement sequence when it is determined by the modification aggregation determination portion that a color image page and a monochrome image page are to be intermixed in the same aggregate page is further included, and when it is determined by the modification aggregation determination portion that a color image page and a monochrome image page are to be intermixed in the same aggregate page, the display controller causes the display to display a message for giving notice that the modification to the arrangement sequence is prohibited as the warning message.

19. An image formation device forming an aggregate page in which a plurality of pages included in a manuscript are aggregated into one page, comprising:
a storage portion for storing information of an attribute of each page;
a display for displaying a preview screen in which icons corresponding to each page included in the manuscript are arranged in page number sequence;
an aggregation determination portion for determining, on the basis of the information of the attribute, whether or not pages the attributes of which are different are to be intermixed in a same aggregate page in a state where each page is arranged in the page number sequence;
an instruction reception portion for receiving, from a user, a modification instruction for instructing to modify arrangement sequence of each page according to modification to arrangement sequence of the icons performed by the user in the preview screen displayed on the display;
a modification aggregation determination portion for determining whether or not the modification to the arrangement sequence results in intermixing of pages the attributes of which are different in a same aggregate page on the basis of the information of the attribute when the instruction reception portion receives the modification instruction; and
a display controller for, when it is determined by the aggregation determination portion and/or the modification aggregation determination portion that pages the attributes of which are different are to be intermixed in the same aggregate page, controlling the display to cause the display to display a warning message.

20. The image formation device as defined in claim 19, wherein
the information of the attribute is information of whether an image of each page is a color image or a monochrome image, and when it is determined by the aggregation determination portion and/or the modification aggregation determination portion that a color image page and a monochrome image page are to be intermixed in the same aggregate page, the display controller causes the display to display a message for giving notice that a color aggregate page is formed or a monochrome aggregate page is formed as the warning message.

21. The image formation device as defined in claim 19, wherein
when the aggregation determination portion and/or the modification aggregation determination portion determines that pages the attributes of which are different are to be intermixed in the same aggregate page, the display displays a preview screen in which the icons are arranged in arrangement sequence before the modification and arrangement sequence after the modification.

22. The image formation device as defined in claim 21, wherein
a page formation portion for forming the aggregate page is further included, the instruction reception portion receives any one of selections of the arrangement sequence before the modification and the arrangement sequence after the modification, and the page formation portion forms the aggregate page in the selected arrangement sequence.

23. The image formation device as defined in claim 16, wherein
the instruction reception portion receives, from the user, a modification instruction for instructing to insert an icon corresponding to a page included in a manuscript targeted for formation of the aggregate page ahead of an icon corresponding to a different page of the manuscript to modify the arrangement sequence of each page.

24. The image formation device as defined in claim 16, wherein
the instruction reception portion receives, from the user, a modification instruction for instructing to insert an icon corresponding to a page included in a manuscript different from the manuscript ahead of an icon corresponding to a page included in the manuscript to modify the arrangement sequence of each page, and when the instruction reception portion receives the modification instruction, the modification aggregation determination portion determines whether or not the modification to the arrangement sequence results in intermixing of pages the attributes of which are different in the same aggregate page on the basis of the information of the attribute and information of an attribute of the page included in the different manuscript.

25. The image formation device as defined in claim 24, wherein
the display arranges icons corresponding to each page of the manuscript in page number sequence and displays a preview screen in which icons corresponding to each page of the different manuscript are arranged in page number sequence.

26. The image formation device as defined in claim 16, wherein
the instruction reception portion receives from the user a modification instruction for instructing to delete a page included in the manuscript to modify the arrangement sequence of each page.

27. The image formation device as defined in claim 16, wherein
the modification aggregation determination portion determines, as to an aggregate page including a first page among the pages whose arrangement sequence is modified, whether or not pages the attributes of which are different are to be intermixed in the aggregate page as well as determines, as to a different aggregate page including a second page which follows the first page, whether or not pages the attributes are which is different are to be intermixed in the different aggregate page.

28. An image formation device forming an aggregate page in which a plurality of pages included in a manuscript are aggregated into one page, comprising:
a storage portion for storing information of an attribute of each page;
an aggregation determination portion for determining whether or not an attribute of a page changes between previous and following pages on the basis of the information of the attribute stored in the storage portion when each page is aggregated in page number sequence to form the aggregate page, and
a page formation portion for performing page break in the aggregate page to form an aggregate page including the following page separately from an aggregate page including the previous page when it is determined by the aggregation determination portion that the attribute of the page changes between the previous and following pages.

29. The image formation device as defined in claim 28, wherein
the attribute is gradation of image data of a page.

30. The image formation device as defined in claim 28, wherein
an instruction reception portion for receiving an edit instruction of arrangement sequence of pages from a user is further included, and when the arrangement sequence of pages is modified, the aggregation determination portion performs the determination.
